(19) United States
(12) Patent Application Publication
(10) Pub. No.: US 2026/0019352 A1
(43) Pub. Date: Jan. 15, 2026

(54) COVERAGE REPORTING TECHNIQUE

(71) Applicant: Telefonaktiebolaget LM Ericsson (publ), Stockholm (SE)

(72) Inventors: Mattias Bergström, Singapore (SG); Marco Belleschi, SOLNA (SE); Antonino Orsino, KIRKKONUMMI (FI)

(21) Appl. No.: 18/996,047

(22) PCT Filed: Aug. 7, 2023
(86) PCT No.: PCT/EP2023/071864

§ 371 Date: Jan. 17, 2025

Related U.S. Application Data
(60) Provisional application No. 63/397,702, filed on Aug. 12, 2022.

(51) Int. Cl. H04L 43/062; H04B 7/06

(52) U.S. Cl. CPC H04L 43/062; H04B 7/06952

(57) ABSTRACT

A coverage reporting technique is described. As to a method aspect of the technique performed by a radio device, a report message is transmitted to a first network node of a radio access network, RAN, associated with a coverage area, the report message being indicative of a coverage status of the radio device relative to the RAN, wherein the report message is indicative of an indirect coverage of the RAN through one or more relay radio devices.

### TECHNICAL FIELD

The present disclosure relates to a technique for reporting coverage. More specifically, and without limitation, methods and devices are provided for reporting relayed coverage.

### BACKGROUND

The Third Generation Partnership Project (3GPP) defined sidelinks (SLs) in 3GPP Release 12 as an adaptation of the radio access technology (RAT) Long Term Evolution (LTE) for direct communication between two radio devices, which are also referred to as user equipments (UE). Direct communication relates to a radio communication without going through a network node of a radio access network (RAN). Such a device-to-device (D2D) communication through the SL is also referred to as proximity service (ProSe). 3GPP enriched SL for public safety and commercial communication use-cases in 3GPP Release 13 and for vehicle-to-everything (V2X) scenarios in 3GPP Release 14.

3GPP further specified SL relaying in 3GPP Release 13 for LTE targeting safety use-cases. Beyond fourth generation (4G) RAT LTE, 3GPP specifies fifth generation (5G) RAT New Radio (NR). SL relaying was included for NR as a working item in the 3GPP Release 17.

SL relaying enables a UE, which is out of direct radio interface connectivity (i.e., Uu connectivity) to a network node of the RAN, to connect to the RAN via a relay UE (i.e., a relay connection). So while there may be a coverage hole in some part of the direct coverage area associated with the RAN, the coverage area associated with the RAN may not be a problem if UEs can in such situations anyway connect to the RAN via a relay UE and in such way get access to the services they require.

However, existing out-of-coverage reports may mislead an operator of the RAN to fill in coverage holes, which actually are not areas where UEs are experiencing outage.

### SUMMARY

Accordingly, there is a need for a coverage reporting technique that takes sidelink (SL) relaying operation into account.

As to a first method aspect, a method performed by a radio device is provided. The method comprises or initiates transmitting a report message to a first network node of a radio access network (RAN) associated with a coverage area. The report message is indicative of a coverage status of the radio device relative to the RAN. More specifically, the report message is indicative of an indirect coverage of the RAN through one or more relay radio devices.

By reporting the indirect coverage of the RAN, i.e., a coverage status in which the radio device is connected to the RAN through one or more relay radio devices, embodiments of the technique enable an operator of the RAN to prioritize an expansion of the RAN, e.g. by identifying holes in the coverage area associated with the RAN that are not covered by the one or more relay radio devices. Same or further embodiments allow determining a ratio of direct coverage area and indirect coverage area, e.g. for assessing reliability of the RAN, energy consumption. Same or further embodiments allow determining the coverage area associated with the RAN as a function of time (e.g. time of day or time of week) due to a pattern of presence of the one or more relay radio devices.

In at least some embodiments, by reporting the coverage status of the radio device relative to the RAN, including the indirect coverage, the RAN can be capable of determining relevant holes in the coverage area of the RAN, e.g. holes that are not indirectly covered through the one or more relay radio devices. For example, a reconfiguration of the RAN and/or the one or more relay radio devices may be prioritized or initiated for one or more holes in the coverage area including the indirect coverage, because the one or more holes include relevant holes that are not even indirectly covered through the one or more relay radio devices.

The transmitting of the report message may also be referred to as reporting.

The report message being indicative of the indirect coverage may comprise the report message being indicative of the coverage status in coverage if (e.g., whenever and/or not only if) the radio device is in indirect coverage. For example, the technique may be implemented by additionally transmitting a conventional report message that is indicative of the coverage status being in-coverage if the radio device is in indirect coverage. Alternatively or in addition, an existing report message that is conventionally indicative of the coverage status being in-coverage only if the radio device is in direct coverage, may be additionally transmitted if the radio device is in indirect coverage.

In same or other embodiments, by reporting the coverage status of the radio device relative to the RAN, including an indication of the indirect coverage that is different (e.g., separate) from an indication of a direct coverage, the RAN can be capable of determining a relevance of one or more holes in the direct coverage of the RAN based on whether or not the report message is (or the report messages received from a plurality of the radio devices are) expressly indicative of the indirect coverage of the RAN for the one or more holes in the direct coverage, respectively. For example, a reconfiguration of the RAN and/or the one or more relay radio devices may be prioritized or initiated for the one or more holes in the direct coverage of the RAN that are not indirectly covered through one or more relay radio devices.

Herein, “coverage” (e.g., or the coverage status “in-coverage”) may encompass a direct coverage and the indirect coverage, i.e. “coverage” may be an umbrella term for a direct coverage and the indirect coverage. Alternatively or in addition, the radio device may be in coverage, if the radio device is in communication (or communication range) with the RAN (e.g., at least one of the first network node and second network nodes) through a Uu interface and/or a PC5 interface.

The direct coverage may encompass radio access provided by a network node (e.g., the first network node and/or at least one second network node) of the RAN directly to the radio device or a plurality of radio devices and/or without an intermediate relay radio device. Alternatively or in addition, the radio device may be in direct coverage of a RAN, if the radio device is in communication (or communication range) with the RAN (e.g., at least one of the first network node and second network nodes) through an uplink (UL) or downlink (DL) interface and/or a Uu interface.

The indirect coverage may encompass radio access provided by a network node (e.g., the first network node and/or at least one second network node) of the RAN indirectly to the radio device or a plurality of radio devices through (e.g., relayed by) the one or more relay radio device. Alternatively or in addition, the radio device may be in indirect coverage of a RAN, if the radio device is in communication (or communication range) with the RAN (e.g., at least one of the first network node and second network nodes) through a sidelink (SL) interface (e.g., a PC5 interface) and/or through the one or more relay radio devices.

The coverage area associated with the RAN may comprise a direct coverage area in which the RAN provides direct coverage to the radio device or a plurality radio devices. Alternatively or in addition, the coverage area associated with the RAN may comprise an indirect coverage area in which the RAN provides indirect coverage to the radio device or a plurality of radio devices through the one or more relay radio devices. For example, the indirect coverage area may comprise one or more subareas. The RAN may provide indirect coverage in each of the one or more subareas through at least one of the one or more relay radio devices. Different subareas may be associated with different relay radio devices. Herein, “at least one of the relay radio devices” may be an abbreviation for “at least one of the one or more relay radio devices”.

The (direct and/or indirect) coverage may encompass a wireless coverage, e.g. a radio coverage. Alternatively or in addition, the (direct and/or indirect) coverage may encompass (e.g., for the radio device relative to the RAN) at least one of a connected state (e.g., a radio resource control, RRC, connected state), an inactive state (RRC inactive state), and an idle state (e.g., an RRC idle state) of the radio device relative to the RAN.

The radio device being in indirect coverage may also be referred to as a remote radio device. Each of the remote radio device and the relay radio device may be in an active state or an idle state (e.g., relative to the RAN).

The indirect coverage (e.g., according to the first method aspect) may be provided through at least one of the relay radio devices by the first network node, optionally by at least one cell or at least one beam of the first network node. Alternatively or in addition, the RAN further may comprise at least one second network node and the indirect coverage is provided through at least one of the relay radio devices by the at least one second network node, optionally by at least one cell or at least one beam of the at least one second network node.

Any feature or step disclosed herein in the context of the first network node may also be comprised in or performed by the second network node, and vice versa.

Preferably, each of the first network node and the at least one second network node may serve (e.g., host) at least one cell. Different network nodes may serve different cells.

The at least one of the relay radio devices may be in direct coverage of the at least one cell or the at least one beam (e.g., of the first network node and/or the at least one second network node).

Herein, referring to the first network node may or may not imply the existence of a second network node. Furthermore, network nodes referred to as first and second network nodes may provide radio access to the radio device and/or may be visited by the radio device in a temporal order that may be different from the numerical order of the first and second network nodes. For example, the radio device may camp on or may be connected to the second network node prior to camping on or being connected to the first network node.

Any network node that is an addressee or receiver of the report message may be referred to as the first network node. For example, the first network node may be serving network node of the RAN currently serving the radio device when the radio device transmits the report message.

Any network node that has been visited (e.g., connected to or camped on) by the radio device in the past and/or any network node that is mentioned in the report message and/or any network node that is not an addressee or receiver of the report message may be referred to as the at least one second network node.

The report message (e.g., according to the first method aspect) may be further indicative of a direct coverage of the RAN.

The report message may be indicative of both the direct coverage and the indirect coverage.

In a first variant, the report message does not distinguish between the direct coverage and the indirect coverage. The report message may be indicative of the coverage area of the RAN including the indirect coverage area. For example, the coverage status may be indicative of whether the radio device is in coverage (also referred to as coverage status “in-coverage”), which is collectively indicative of both direct coverage and indirect coverage, or out of coverage (also referred to as coverage status “out-of-coverage”).

In a second variant, the report message may distinguish between the direct coverage and the indirect coverage. That is, the report message may distinguish between two types of the coverage including the direct coverage and the indirect coverage. For example, the coverage status may distinguish between each of the radio device being in direct coverage, the radio device being in indirect coverage, and the radio device being out of coverage.

In any variant, the report message may comprise further (e.g., more detailed) information related to the coverage status of the radio device.

The direct coverage (e.g., according to the first method aspect) may be provided by the first network node, optionally by at least one cell or at least one beam of the first network node. Alternatively or in addition, the RAN further may comprise at least one second network node and the direct coverage is provided by the at least one second network node, optionally by at least one cell or at least one beam of the at least one second network node.

The message may be sent to the network node that the radio device is in communication with. Alternatively or in addition, the message may be sent to a secondary network node (e.g., in case of dual connectivity and/or the handover procedure).

The report message (e.g., according to the first method aspect) may differentiate between the direct coverage and the indirect coverage.

The report message may be indicative of the coverage status by indicating whether the coverage status is the result of the direct coverage or the indirect coverage. The report message may be indicative of the direct coverage and the indirect coverage separately from each other.

The report message (e.g., according to the first method aspect) may be indicative of the direct coverage and the indirect coverage indistinguishably from each other within the report.

The report message may indicate the direct coverage and the indirect coverage collectively, e.g. without differentiating between the direct coverage and the indirect coverage. The radio device may be able to distinguish the direct coverage and the indirect coverage. The two cases may be merged (e.g., indicated equally) in the report message everything.

The report message (e.g., according to the first method aspect) may be further indicative of lacking coverage of the radio device relative to the RAN.

The lacking coverage may encompass the coverage status being out-of-coverage, i.e., the radio device being out of coverage of the RAN. Alternatively or in addition, the lacking coverage may encompass the absence of radio access, e.g. according to a radio access technology (RAT) of the RAN. Alternatively or in addition, the lacking coverage may encompass the absence of direct coverage and the absence of indirect coverage of the RAN.

Alternatively or in addition, the radio device may be in coverage (e.g., the coverage status may be “in-coverage”) if a signal metric associated with a radio link between the radio device and the RAN (e.g., any network node of the RAN and/or any of the one or more relay radio devices) is greater than a predefined first threshold value. Optionally, the radio device may apply different first thresholds values for determining itself to be in coverage using a Uu interface (e.g., for a direct radio link to the RAN) and using a PC5 interface (e.g., for a relay radio link to any of the one or more relay radio devices). Alternatively or in addition, the radio device may be out of coverage (e.g., the coverage status may be “out of coverage”) if a signal metric associated with the radio link is less than a predefined second threshold value (e.g., equal to or less than the first threshold value). Optionally, the radio device may apply different second thresholds values for determining itself to be out of coverage using a Uu interface (e.g., a direct radio link to the RAN) and using a PC5 interface (e.g., a relay radio link to any of the one or more relay radio devices).

Herein, “predefined” may encompass “configured” (e.g., by means of a configuration message from the RAN) and/or “defined” by a technical specification of the RAT.

The lacking coverage (e.g., according to the first method aspect) may comprise the absence of both direct coverage of the RAN and indirect coverage of the RAN.

The lacking coverage may comprise the absence of both direct coverage and indirect coverage from any node, any cell, and/or any cell of the RAN. Alternatively or in addition, the lacking coverage may comprise the absence of both direct coverage and indirect coverage from the first network node, optionally from any cell and/or any beam of the first network node, and/or the absence of direct coverage and indirect coverage from the at least one second network node, optionally from any cell and/or any beam of the at least one second network node.

The report message (e.g., according to the first method aspect) may be further indicative of at least one of an identity and/or a number and/or a signal metric of at least one of the respective network node, the cell, and the beam providing the indirect coverage; an identity and/or a number and/or a signal metric of the respective relay radio device through which the indirect coverage is provided; an identity and/or a number and/or a signal metric of at least one of the respective network node, the cell, and the beam providing the direct coverage; and an identity and/or a number and/or a signal metric of at least one of the respective network node, the cell, and the beam causing the lacking coverage.

Herein, referring to the at least one of the respective network node may refer to the first network node and/or the at least one second network node. Alternatively or in addition, referring to the respective relay radio device may refer to at least one of the one or more relay radio devices.

The first network node and/or the at least one second network node may provide the indirect coverage and/or the direct coverage using at least one cell. The report message may be further indicative of an identity of the at least one cell providing the indirect coverage and/or the direct coverage.

Any identity (ID) may be an identifier or identification.

The report message may be indicative of the coverage status and/or the identity and/or the signal metric for each of a plurality of the first network node and/or the at least one second network node or a plurality of cells or beams of the first network node and/or the at least one second network node.

Any identity of a cell may be a cell-ID (CI), e.g. a physical cell ID (PCI). Each of the first network node and/or the at least one second network node may comprise at least one cell. Each cell may be associated with a respective cell-ID. The cell-ID of the indirect coverage may be forwarded by the respective relay radio device according to the cell providing the direct coverage to the respective one of the relay radio devices.

Alternatively or in addition, the first network node and/or the at least one second network node may provide the indirect coverage and/or the direct coverage using at least one beam. The report message may be further indicative of an identity of the at least one beam providing the indirect coverage and/or the direct coverage.

The signal metric (e.g., of the first and/or second network node and/or relay radio devices) may be measured by and/or at the radio device.

Herein, any signal metric may comprise at least one of signal-to-noise ratio (SNR), signal-to-interference-plus-noise-ratio (SINR), reference signal received power (RSRP), reference signal received quality (RSRQ), and received signal strength indicator (RSSI).

The report message (e.g., according to the first method aspect) may be indicative of a sequence and/or a map of the coverage status of the radio device, optionally comprising at least one of a sequence and/or a map of the indirect coverage; a sequence and/or a map of the direct coverage; and a sequence and/or a map of the lacking coverage.

The sequence may be a temporal sequence. The report message may be indicative of a sequence of the coverage status by indicating the coverage status of the radio device at different time (e.g., for a sequence of time intervals). Alternatively or in addition, the report message may be indicative of a sequence of changes of the coverage status.

The report message may be indicative of a map of the coverage status by indicating the coverage status of the radio device at different locations of the radio device. Alternatively or in addition, the report message may be indicative of the coverage status for each of one or more locations of the radio device.

The sequence and/or the map may comprise a list of the identities of the first network node and/or the at least one second network node. Alternatively or in addition, the sequence and/or the map may comprise a list of the one or more identities of the one or more relay radio devices. Each of the identities (e.g., for the network nodes and/or the relay radio devices) in the list (e.g., in a table) may be associated with the coverage status of the radio device and/or the signal metric measured at the radio device and/or the location of the radio device.

The sequence and/or the map may be implemented as (e.g., an extension of) a mobility history information (MHI).

The coverage status of the radio device (e.g., according to the first method aspect) may comprise a multi-connectivity (MC) of the radio device concurrently using multiple independent radio paths to the RAN. At least one or each of the multiple radio paths uses the indirect coverage of the RAN through at least one of the one or more relay radio devices.

Different radio paths (e.g., using the indirect coverage of the RAN) may use different relay radio devices.

The coverage status of the radio device may comprise a multi-connectivity (MC), e.g. a dual connectivity (DC). The multiple radio paths may also be referred to as multiple connections.

The radio device in the MC may concurrently use multiple independent radio paths to the first network node and/or the at least one second network node. For example, the radio device in the MC may be simultaneously connected to multiple network nodes (e.g., at least two of the first network node and/or the at least one second network node).

At least one of the multiple radio paths may be through at least one of the one or more relay radio devices. That is, at least one of the multiple connections may be relayed through at least one of the one or more relay radio devices.

The coverage status of the radio device (e.g., according to the first method aspect) may comprise a handover (HO) of the radio device from a source radio path between the radio device and the RAN to a target radio path between the radio device and the RAN. At least one or each of the source radio path and the target radio path may use the indirect coverage of the RAN through at least one of the one or more relay radio devices.

The source radio path may comprise at least one of the first network node and the at least one second network node. Alternatively or in addition, the target radio path may comprise at least one of the first network node and the at least one second network node.

The coverage status of the radio device (e.g., according to the first method aspect) may comprise the direct coverage of the RAN while the radio device discovers at least one of the one or more relay radio devices through which the indirect coverage of the RAN is provided. Alternatively or in addition, the radio device may use concurrently the direct coverage and the indirect coverage for a or the MC of the radio device. Alternatively or in addition, the radio device may be handed over from the direct coverage to the indirect coverage.

The relay radio device though which the indirect coverage is provided may use the same or another network node (e.g., the first network node and/or the at least one second network node) providing the direct coverage.

The coverage status of the radio device may be in direct coverage of the RAN (e.g., the direct coverage is provided by the second network node), while discovering a relay radio device (e.g., a sidelink relay) for indirect coverage of the RAN. For example, when the radio device is in direct coverage or moving out of the direct coverage (e.g., provided by the second network node), the radio device may initiate a discovery of at least one of the one or more relay radio devices. Prior to or responsive to moving out of the direct coverage (e.g., provided by the second network node), the radio device may establish a sidelink connection to the relay radio device for the indirect coverage (e.g., provided by the same second network node or another one of the second network nodes or the first network node).

Alternatively or in addition, the coverage status of the radio device may be in indirect coverage of the RAN (e.g., the indirect coverage may be provided by the first network node) through a relay radio device, while discovering at least one other relay radio device.

The coverage status of the radio device (e.g., according to the first method aspect) may comprise the indirect coverage of the RAN through a first relay radio device of the relay radio devices while the radio device discovers a second relay radio device of the relay radio devices through which the indirect coverage of the RAN is provided. Alternatively or in addition, the radio device may use concurrently the indirect coverage through the first relay radio device and the indirect coverage through the second relay radio device for a or the MC of the radio device, Alternatively or in addition, the radio device may be handed over from the indirect coverage through the first relay radio device to the indirect coverage through the second relay radio device.

The first relay radio device and the second relay radio device may be in (e.g., direct) radio connection with the same or different network nodes (e.g., the first network node and/or the at least one second network node). That is, the same or different network nodes may provide the indirect coverage for the radio device.

Alternatively or in addition, the coverage status of the radio device may be in indirect coverage of the RAN (e.g., the indirect coverage is provided by the first network node) and discovering a second network node for direct coverage of the RAN.

In case of direct coverage of the RAN, the message may be indicative of a cell-ID and/or the network node-ID (e.g., the second network node-ID) that the radio device is in direct coverage of.

In case of the indirect coverage of the RAN, the message may be indicative of a cell-ID and/or the network node-ID that the relay radio device is in the coverage of (e.g., the first network node-ID that the radio device is in indirect coverage of).

The storing of information at the radio device as to the coverage status and/or the transmitting of the report message (e.g., according to the first method aspect) may be triggered by at least one of: receiving a configuration message or a request message from the RAN; determining the lacking coverage of the RAN; establishing a connection with, or camping on, the first network node using the direct coverage or using the indirect coverage; establishing a connection with, or camping on, the at least one second network node using the direct coverage or using the indirect coverage; discovering, by the radio device, the one or more relay radio devices or at least one of the one or more relay radio devices for the indirect coverage; discovering, by the radio device, the first network node or the at least one second network node of the RAN; establishing a sidelink to at least one of the one or more relay radio devices; a change in the coverage status of the radio device relative to the RAN; and an expiry of a predefined period of time.

The method may further comprise any one of the above triggering steps (e.g., measuring the change of the coverage status or maintaining a time that expires). For example, the report message may be transmitted periodically.

The connection with the first network node and/or the at least one second network node may refer to the connected state relative to the RAN. The connection may be a radio resource control (RRC) connection. Alternatively or in addition, the radio device may camp on the first network node and/or the at least one second network node in the idle state relative to the RAN.

The method (e.g., according to the first method aspect) may further comprise or initiate transmitting a status message to the RAN, optionally to the first network node or the at least one second network node.

The status message may be transmitted from the radio device. The status message may be a capability message of the radio device and/or may indicated information that is stored (e.g., logged) at the radio device as to the coverage status, e.g., as to the indirect coverage.

At least one of the status message and the report message (e.g., according to the first method aspect) may be indicative of an availability of information at the radio device as to the coverage status of the radio device relative to the RAN. The status message may be indicative of different time spans and/or different locations for which the information at the radio device as to the coverage status of the radio device relative to the RAN is available. Alternatively or in addition, at least one of the status message and the report message (e.g., according to the first method aspect) may be indicative of an availability of information at the radio device as to the indirect coverage of the RAN through one or more relay radio devices. The status message may be indicative of different time spans and/or different locations for which the information at the radio device as to the indirect coverage of the RAN is available. Alternatively or in addition, at least one of the status message and the report message (e.g., according to the first method aspect) may be indicative of an availability of information at the radio device as to the direct coverage of the RAN. The status message may be indicative of different time spans and/or different locations for which the information at the radio device as to the direct coverage of the RAN is available. Alternatively or in addition, at least one of the status message and the report message (e.g., according to the first method aspect) may be indicative of an availability of information at the radio device as to the lacking coverage of the RAN. The status message may be indicative of different time spans and/or different locations for which the information at the radio device as to the lacking coverage of the RAN is available. Alternatively or in addition, at least one of the status message and the report message (e.g., according to the first method aspect) may be indicative of a time span of the radio device being in indirect coverage of the RAN, optionally per network node or per cell or per beam or per relay radio device. Alternatively or in addition, at least one of the status message and the report message (e.g., according to the first method aspect) may be indicative of a capability of the radio device to be in or use the indirect coverage of a RAN, optionally per radio access technology (RAT) of the RAN or per RAT of a sidelink between the radio device and the at least one relay radio device. Alternatively or in addition, at least one of the status message and the report message (e.g., according to the first method aspect) may be indicative of a time span of the radio device being in direct coverage of the RAN, optionally per network node or per cell or per beam. Alternatively or in addition, at least one of the status message and the report message (e.g., according to the first method aspect) may be indicative of a time span of the radio device being out of coverage of the RAN. Alternatively or in addition, at least one of the status message and the report message (e.g., according to the first method aspect) may be indicative of a number and/or a list of identities of the one or more relay radio devices through which the radio device is or has been in indirect coverage of the RAN, optionally per network node or per cell or per beam. Alternatively or in addition, at least one of the status message and the report message (e.g., according to the first method aspect) may be indicative of a frequency on which the indirect coverage is provided through the at least one relay radio device, optionally per network node or per cell or per beam or per relay radio device. Alternatively or in addition, at least one of the status message and the report message (e.g., according to the first method aspect) may be indicative of a signal metric of the RAN measured at the relay radio device through which the indirect coverage is provided, optionally per network node or per cell or per beam or per relay radio device. Alternatively or in addition, at least one of the status message and the report message (e.g., according to the first method aspect) may be indicative of a signal metric of the relay radio device measured at the radio device for the indirect coverage, optionally per network node or per cell or per beam or per relay radio device. Alternatively or in addition, at least one of the status message and the report message (e.g., according to the first method aspect) may be indicative of a radio access technology and/or a type and/or a mode of a sidelink between the radio device and the relay radio device.

The signal metric of the RAN may comprise any one of the signal metrics disclosed herein. The signal metric of the RAN (e.g., of the first and/or the at least one second network node) measured at the relay radio device may be a downlink signal metric.

The report message may be indicative of a received signal strength indicator (RSSI) of the RAN at the relay radio device for the indirect coverage, optionally per network node or per cell or per beam or per relay radio device. Alternatively or in addition, report message may be indicative of a reference signal received power (RSRP) of the RAN at the relay radio device for the indirect coverage, optionally per network node or per cell or per beam or per relay radio device. Alternatively or in addition, the report message may be indicative of a reference signal received quality (RSRQ) of the RAN at the relay radio device for the indirect coverage, optionally per network node or per cell or per beam or per relay radio device. Alternatively or in addition, the report message may be indicative of a signal-to-noise and interference ratio (SINR) of the RAN at the relay radio device for the indirect coverage, optionally per network node or per cell or per beam or per relay radio device.

The signal metric of the relay radio device may comprise any one of the signal metrics disclosed herein. The signal metric of the relay radio device measured at the radio device may be a sidelink signal metric.

Alternatively or in addition, the report message may be indicative of a sidelink received signal strength indicator (S-RSSI) of the relay radio device at the radio device for the indirect coverage, optionally per network node or per cell or per beam or per relay radio device. Alternatively or in addition, the report message may be indicative of a sidelink reference signal received power (S-RSRP) of the relay radio device at the radio device for the indirect coverage, optionally per network node or per cell or per beam or per relay radio device. Alternatively or in addition, the report message may be indicative of a sidelink reference signal received quality (S-RSRQ) of the relay radio device at the radio device for the indirect coverage, optionally per network node or per cell or per beam or per relay radio device. Alternatively or in addition, the report message may be indicative of a signal-to-noise and interference ratio (SINR) of the relay radio device at the radio device for the indirect coverage, optionally per network node or per cell or per beam or per relay radio device.

Any time span may be indicated by the sequence or a list of time spans (e.g., per network node and/or per cell and/or per beam) and/or a sum of the time (e.g., within an observation time) and/or a time share (e.g., a ratio of the time spans or the sum of the time relative to an observation time).

The report message being indicative per network node may encompass the report message being indicative per the first network node and/or per (e.g., each of) the at least one second network node. For example, the report message may be indicative of the time span of the radio device being in the indirect coverage or the direct coverage of a certain second network node of the RAN or a certain cell of a certain second network node of the RAN or a certain beam of a certain second network node of the RAN. Alternatively or in addition, the report message may be indicative of a time span of the radio device being in a certain cell or each cell of the direct coverage of the first network node and/or each of the at least one second network node of the RAN. Alternatively or in addition, the report message may be indicative of a time span of the radio device being in indirect coverage of the first network node and/or each of the at least one second network node of the RAN, e.g., for each of the one or more relay radio devices through which the indirect coverage is provided.

The RSSI of the RAN at the relay radio device may be based on a cell-specific reference signal (CRS) of the RAN and/or a channel state information (CSI) reference signal (CSI-RS) of the RAN.

The information transmitted to the first network node and/or the at least one second network node of the RAN by means of the report message may be used by the respective network node (e.g., by first network node and/or the at least one second network node), e.g. for at least one of scheduling radio resources, configured grants for the radio device or any radio devices, controlling transmit power, and extending or reducing a range of the direct coverage by the respective network node.

The method may further comprise or initiate the step of receiving a configuration message from the RAN, optionally from the first network node or the at least one second network node. The configuration message may be received in response to the status message.

The method (e.g., according to the first method aspect) may further comprise or initiate receiving a request message or the above-mentioned request message from the RAN, optionally from the first network node or the at least one second network node, or from the one or more relay radio devices.

The request message may be indicative of initiating the transmitting of the response message.

The request message may be directly received from the RAN, i.e., using the direct coverage, e.g. from the first network node and/or the at least one second network node of the RAN. Alternatively or in addition, the request message may be indirectly received from the RAN, i.e. using the indirect coverage, e.g. from the first network node and/or the at least one second network node of the RAN through at least one of the one or more relay radio devices. Alternatively or in addition, the request message may be directly received from the one or more relay radio devices.

The report message (e.g., according to the first method aspect) may be transmitted to the first network node of the RAN according to and/or responsive to a request message (or the above-mentioned request message) received from the RAN. Alternatively or in addition, the report message may be indicative of one or more time spans and/or one or more locations for which the coverage status of the radio device relative to the RAN and/or for which the indirect coverage of the RAN and/or for which the direct coverage of the RAN and/or for which the lacking coverage of the RAN is to be indicated in the report message.

The request message may refer to the time spans and/or the locations indicated in the status message.

The radio device may transmit a part of the stored information (e.g., a saved log file) based on the received request message (e.g., an order, e.g. from the RAN or the relay radio device). The received message may be indicative of a desired content of the report message from the radio device to be transmitted, for example, the coverage status of a certain time, a recent coverage status, any change in recent coverage status, etc.

The report message (e.g., according to the first method aspect) may be indicative of the coverage status of the radio device relative to the RAN within a predefined period of time and/or for a predefined number of states or changes of the coverage status of the radio device relative to the RAN.

The request message and/or the configuration message may be indicative of at least one of the predefined first threshold value, the predefined second threshold value, a predefined period of time for which the coverage status is to be indicated in the report message and/or a predefined number of states (or changes) of the coverage status of the radio device relative to the RAN that are to be indicated in the report message.

The radio device may store (which may also be referred to as logging) the predefined number states or changes of the coverage status and/or over the predefined period of time (e.g., in an internal memory of the radio device). Alternatively or in addition, the radio device may store (e.g., in an internal memory) a limited number of states or changes of the coverage status, e.g., 16, 32, or 64 states or changes of the coverage status.

The report message (e.g., according to the first method aspect) may be transmitted to the first network node of the RAN directly from the radio device. Alternatively or in addition, the report message may be transmitted to the first network node of the RAN indirectly from the radio device through the one or more relay radio devices.

The report message (e.g., according to the first method aspect) may be configured to trigger at the RAN at least one of configuring or preemptively configuring the radio device and/or another radio device with a sidelink configuration for the indirect coverage indicated in the report message, optionally when the radio device and/or the other radio device is predicted to move to a location for which the report message is indicative of the indirect coverage and/or if the report message is indicative of a time span for the indirect coverage that is greater than a predefined time threshold or that is greater than a time span for the direct coverage; and refraining from configuring the radio device and/or another radio device with a sidelink configuration, optionally when the radio device and/or the other radio device is predicted to move to a location for which the report message is indicative of the direct coverage and/or if the report message is indicative of a time span for the indirect coverage that is less than a predefined time threshold or that is less than a time span for the direct coverage.

As to a second method aspect, a method performed by a relay radio device is provided. The method comprises or initiates receiving a report message from a radio device that is out of direct coverage of a radio access network (RAN) the report message being indicative of a coverage status of the radio device relative to the RAN. The report message is indicative of an indirect coverage of the RAN through one or more relay radio devices. The method further comprises or initiates transmitting the report message to a first network node of the RAN.

The one or more relay radio devices may be, or may comprise, the relay radio device performing the method (e.g., the second method aspect).

The receiving of the report message and the transmitting of the report message may encompass forwarding and/or processing the report message.

The method (e.g., according to the second method aspect) may further comprise or initiate at least one of forwarding to the RAN a status message from the radio device; and transmitting or forwarding, to the radio device, a request message or a configuration message, optionally indicative of a scope or content of the report message or a configuration for reporting the coverage status of the radio device and/or responsive the status message.

The method (e.g., according to the second method aspect) may further comprise any of the features or steps of the first method aspect. The second method aspect may further comprise any feature and/or any step disclosed in the context of the first method aspect, or a feature and/or step corresponding thereto, e.g., a receiver counterpart to a transmitter feature or step.

As to a third method aspect, a method performed by a first network node of a radio access network (RAN) associated with a coverage area is provided. The method comprises or initiates receiving a report message from a radio device, the report message being indicative of a coverage status of the radio device relative to the RAN. The report message is indicative of an indirect coverage of the RAN through one or more relay radio devices.

The report message may be received directly from the radio device or through the one or more relay radio devices.

The method (e.g., according to the third method aspect) may further comprise or initiate transmitting a request message to the radio device. The third method aspect may further comprise any feature and/or any step disclosed in the context of the first and/or second method aspect, or a feature and/or step corresponding thereto, e.g., a network counterpart to a radio device feature or step.

The request message may be indicative of one or more time spans and/or one or more locations for which the coverage status of the radio device relative to the RAN, (e.g., the indirect coverage of the RAN, the direct coverage of the RAN, and/or the lacking of coverage of the RAN) is to be indicated in the report message.

The report message may be transmitted according to and/or in response to the request message.

The request message may be indicative of triggering the radio device to transmit the report message (e.g., to the RAN or to the first network node).

The request message may be a configuration message. The request message or the configuration message may be indicative a configuration for the radio device to measure and/or store and/or report (e.g., by means of the report message) the coverage status of the radio device relative to the RAN. For example, the request message or the configuration message may be indicative of a scope or content of the report message.

The method (e.g., according to the third method aspect) may further comprise or initiate receiving a status message from the radio device.

The status message may be indicative of one or more time spans and/or one or more locations for which information as to the coverage status of the radio device relative to the RAN is available (e.g., stored at the radio device). The request message may be transmitted in response to the status message. Alternatively or in addition, the request message may refer to a subset of the one or more time spans and/or the one or more locations indicated in the status message (which may also be referred to as down-selecting by the RAN).

The method (e.g., according to the third method aspect) may further comprise or initiate configuring or preemptively configuring the radio device and/or another radio device with a sidelink configuration for the indirect coverage indicated in the report message, optionally when the radio device and/or the other radio device is predicted to move to a location for which the report message is indicative of the indirect coverage and/or if the report message is indicative of a time span for the indirect coverage that is greater than a predefined time threshold or that is greater than a time span for the direct coverage.

Alternatively or in addition, the method (e.g., according to the third method aspect) may further comprise or initiate refraining from configuring the radio device and/or another radio device with a sidelink configuration, optionally when the radio device and/or the other radio device is predicted to move to a location for which the report message is indicative of the direct coverage and/or if the report message is indicative of a time span for the indirect coverage that is less than a predefined time threshold or that is less than a time span for the direct coverage.

The method (e.g., according to the third method aspect) may further comprise any one of the steps of the first method aspect and/or the second method aspect.

As to another aspect, a computer program product is provided. The computer program product comprises program code portions for performing any one of the steps of any one, or multiple of, the first and/or second and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a radio device is provided. The radio device comprises memory operable to store instructions and processing circuitry operable to execute the instructions, such that the radio device is operable to transmit a report message to a first network node of a radio access network (RAN) associated with a coverage area, the report message being indicative of a coverage status of the radio device relative to the RAN. The report message is indicative of an indirect coverage of the RAN through one or more relay radio devices.

The radio device (e.g., according to the first device aspect) may be further operable to perform any one of the steps of the first method aspect.

As to another first device aspect, a radio device is provided. The radio device is configured to transmit a report message to a first network node of a radio access network (RAN) associated with a coverage area, the report message being indicative of a coverage status of the radio device relative to the RAN. The report message is indicative of an indirect coverage of the RAN through one or more relay radio devices.

Alternatively or in addition, the device may be configured to perform any one of the steps of any one of the method aspects. As to a further device aspect, a device is provided, which comprises processing circuitry (e.g., at least one processor and a memory). Said memory comprises instructions executable by said at least one processor whereby the device is operative to perform any one of the steps of the any one of the method aspects.

The radio device (e.g., according to another first device aspect) may further configured to perform any of the steps of the first method aspect.

The radio device may be a user equipment (UE).

As to a second device aspect, a relay radio device is provided. The relay radio device comprises memory operable to store instructions and processing circuitry operable to execute the instructions, such that the relay radio device is operable to receive a report message from a radio device that is out of direct coverage of a radio access network (RAN) the report message being indicative of a coverage status of the radio device relative to the RAN. The report message is indicative of an indirect coverage of the RAN through one or more relay radio devices. The relay radio device is further operable to transmit the report message to a first network node of the RAN.

The relay radio device (e.g., according to the second device aspect) may be further operable to perform any one of the steps of the second method aspect.

As to another second device aspect, a relay radio device is provided. The relay radio device is configured to receive a report message from a radio device that is out of direct coverage of a radio access network (RAN), the report message being indicative of a coverage status of the radio device relative to the RAN. The report message is indicative of an indirect coverage of the RAN through one or more relay radio devices. The relay radio device is further configured to transmit the report message to a first network node of the RAN.

The relay radio device (e.g., according to another second device aspect) may further be configured to perform any one of the steps of the second method aspect.

As to a third device aspect, a network node is provided. The network node comprises memory operable to store instructions and processing circuitry operable to execute the instructions, such that the network node is operable to receive a report message from a radio device, the report message being indicative of a coverage status of the radio device relative to the RAN. The report message is indicative of an indirect coverage of the RAN through one or more relay radio devices.

The network node (e.g., according to the third device aspect) may be further operable to perform any one of the steps of the third method aspect.

As to another third device aspect, a network node is provided. The network node is configured to receive a report message from a radio device, the report message being indicative of a coverage status of the radio device relative to the RAN. The report message is indicative of an indirect coverage of the RAN through one or more relay radio devices.

The network node (e.g., according to another third device aspect) may be further configured to perform any one of the steps of the third method aspect.

The network node may be a base station.

As to a system aspect, a communication system including a host computer comprising processing circuitry configured to provide user data; and a communication interface configured to forward user data to a cellular or ad hoc radio network for transmission to a user equipment (UE) is provided. The UE comprises a radio interface and processing circuitry, the processing circuitry of the UE being configured to execute any one of the steps of the first method aspect and/or the second method aspect.

As to a still further aspect, a communication system including a host computer is provided. The host computer comprises a processing circuitry configured to provide user data, e.g., included in the user data of a data transmission using the indirect coverage. The host computer further comprises a communication interface configured to forward the user data to a cellular network (e.g., the RAN and/or the first network node and/or the at least one second network node) for transmission to a UE (e.g. the radio device). A processing circuitry of the cellular network is configured to execute any one of the steps of the third method aspect.

The communication system may further include the UE. Alternatively, or in addition, the cellular network may further include one or more base stations (e.g., the first network node and/or the at least one second network node) configured for radio communication with the UE and/or to provide a data link between the UE and the host computer using the third method aspect.

The communication system (e.g., according to the system aspect), wherein the base station, or the radio device functioning as a gateway, may comprise processing circuitry, which may be configured to execute any one of the steps of the third method aspect.

The processing circuitry of the host computer may be configured to execute a host application, thereby providing the user data and/or any host computer functionality described herein. Alternatively, or in addition, the processing circuitry of the UE may be configured to execute a client application associated with the host application.

At least some method embodiments of any method aspect can configure the radio device and/or the one or more relay radio devices and/or the RAN based on the report message, e.g. to ensures that the traffic of the radio device fulfils a required Quality of Service (Qos).

Without limitation, for example in a 3GPP implementation, any “radio device” may be a user equipment (UE). Any one of the method aspects may be embodied by a method of establishing a UE relaying connection with a desired QoS.

The technique may be applied in the context of 3GPP New Radio (NR). Unlike a SL according to 3GPP LTE, a SL according to 3GPP NR can provide a wide range of Qos levels. Therefore, at least some embodiments of the technique can ensure that the radio device and/or the one or more relay radio devices and/or the RAN are configured for the QoS of the traffic of the radio device.

In any radio access technology (RAT), the technique may be implemented by a method of coverage reporting for relaying, or a method of performing a Self-Organizing Network (SON), or a method for Minimization of Drive Tests (MDT).

Any relay connection may include a sidelink (SL). Any relay radio device may be configured to provide radio access to the radio device by means of a SL. The SL may be implemented using proximity services (ProSe), e.g. according to a 3GPP specification.

In any embodiment, the report message may be indicative of in-coverage and/or out-of-coverage as the coverage status relative to the RAN. The report message may be indicative of the coverage of the RAN including indirect coverage and/or distinguish between direct and indirect coverage. Alternatively or in addition, the report message may further be indicative of the direct coverage, optionally as an extension of mobility history information (MIH).

Any radio device may be a user equipment (UE), e.g., according to a 3GPP specification. The relay radio device may also be referred to as a relay UE (or briefly: relay). Alternatively or in addition, the remote radio device may also be referred to as a remote UE.

The relay radio device and the RAN may be wirelessly connected in an uplink (UL) and/or a downlink (DL) through a Uu interface. Alternatively or in addition, the SL may enable a direct radio communication between proximal radio devices, e.g., the remote radio device and the relay radio device, optionally using a PC5 interface. Services provided using the SL or the PC5 interface may be referred to as proximity services (ProSe). Any radio device (e.g., the remote radio device and/or the relay radio device and/or the further radio device) supporting a SL may be referred to as ProSe-enabled radio device.

The relay radio device may also be referred to as ProSe UE-to-Network Relay. The radio device performing the first method aspect may be a remote radio device (or a directly connected radio device) depending on the current coverage status of the radio device being indirect coverage (or direct coverage, respectively).

The radio device (e.g. acting as a remote radio device) and/or the one or more relay radio devices and/or the RAN may form, or may be part of, a radio network (briefly: network), e.g., according to the Third Generation Partnership Project (3GPP) or according to the standard family IEEE 802.11 (Wi-Fi). The first method aspect, the second method aspect, and third method aspect may be performed by one or more embodiments of the (e.g. temporarily remote) radio device, any one of the one or more relay radio devices, and the RAN (e.g., the first network node of the RAN, optionally acting as a base station), respectively.

The RAN may comprise one or more network nodes (e.g., base stations), e.g., performing the third method aspect. Alternatively or in addition, the radio network may be a vehicular, ad hoc and/or mesh network comprising two or more radio devices, e.g., acting as the remote radio device and/or the relay radio device and/or the further remote radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations (e.g., the first network node and/or the at least one second network node).

The (e.g., temporarily) remote radio device may be (e.g., temporarily) wirelessly connected or connectable (e.g., according to a PC5 radio resource control, RRC, state or active mode) with the relay radio device and, optionally, the first network node and/or the at least one second network node of the RAN. The relay radio device may be wirelessly connected or connectable (e.g., according to a radio resource control, RRC, state or active mode) with at least one base station of the RAN and/or the further remote radio device. Furthermore, the relay radio device may be wirelessly connected or connectable (e.g., according to 3GPP ProSe) with the remote radio device.

The first network node and/or the at least one second network node may be a base station, e.g. may encompass any station that is configured to provide radio access to any of the radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

Any one of the radio device, the UE, the base stations, the first network node, the at least one second network node, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for reporting a coverage status;

FIG. 2 shows a schematic block diagram of an embodiment of a device for forwarding a coverage status;

FIG. 3 shows a schematic block diagram of an embodiment of a device for receiving a coverage status;

FIG. 4 shows a flowchart for a method of reporting a coverage status, which method may be implementable by the device of FIG. 1;

FIG. 5 shows a flowchart for a method of forwarding a coverage status, which method may be implementable by the device of FIG. 2;

FIG. 6 shows a flowchart for a method of receiving a coverage status, which method may be implementable by the device of FIG. 3;

FIG. 7 schematically illustrates a first example of a radio network comprising embodiments of the devices of FIGS. 1, 2, and 3 for performing the methods of FIGS. 4, 5, and 6, respectively;

FIG. 8 schematically illustrates a second example of a radio network comprising embodiments of the devices of FIGS. 1, 2, and 3 for performing the methods of FIGS. 4, 5, and 6, respectively;

FIG. 9A schematically illustrates a first example of protocol stacks implementable at embodiments of the devices of FIGS. 1, 2, and 3 performing the methods of FIGS. 4, 5, and 6, respectively;

FIG. 9B schematically illustrates a first second example of protocol stacks implementable at embodiments of the devices of FIGS. 1, 2, and 3 performing the methods of FIGS. 4, 5, and 6, respectively;

FIG. 10 schematically illustrates an example of a signaling diagram resulting from embodiments of the devices of FIGS. 1, 2, and 3 performing the methods of FIGS. 4, 5, and 6, respectively;

FIG. 11 shows a schematic block diagram of a (e.g., temporally remote) radio device embodying the device of FIG. 1;

FIG. 12 shows a schematic block diagram of a relay radio device embodying the device of FIG. 2;

FIG. 13 shows a schematic block diagram of a first network node of a radio access network embodying the device of FIG. 3;

FIG. 14 schematically illustrates an example telecommunication network connected via an intermediate network to a host computer;

FIG. 15 shows a generalized block diagram of a host computer communicating via a base station or radio device functioning as a gateway with a user equipment over a partially wireless connection; and

FIGS. 16 and 17 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

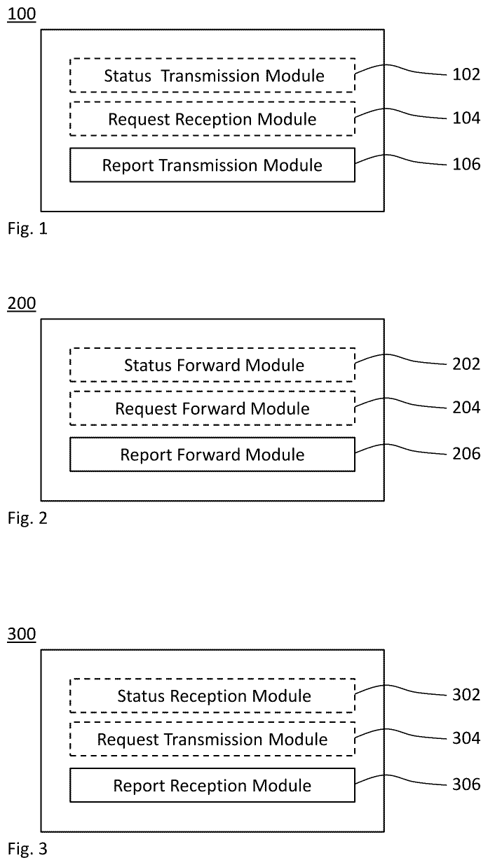

FIG. 1 schematically illustrates a block diagram of an embodiment of a device according to the first device aspect. The device is generically referred to by reference sign 100.

The device 100 comprises one or several modules that enable the functionality described in the first method aspect. The device includes an optional Status Transmission module 102, an optional Request Reception module 104, and a Report Transmission module 106.

The optional Status Transmission module 102 is responsible for transmitting a status message to the radio access network (RAN). This module may also include the functionality to indicate the availability of information related to the coverage status of the device relative to the RAN. Additionally, it may indicate the availability of information related to the direct coverage, indirect coverage, and lacking coverage of the RAN. It may also provide information regarding the time span for which the coverage status, direct coverage, indirect coverage, or lacking coverage is available.

The optional Request Reception module 104 is responsible for receiving request messages from the RAN. These request messages may trigger the transmitting of the response message by the device. The module may also indicate whether the coverage status of the device, indirect coverage, direct coverage, or lacking coverage is to be indicated in the report message.

The Report Transmission module 106 is responsible for transmitting a report message to the first network node of the RAN. This module may also include functionality to differentiate between the direct coverage and the indirect coverage in the report message if required. It may also indicate the time spans and/or locations for which the coverage status, direct coverage, indirect coverage, or lacking coverage is to be indicated in the report. Additionally, the module may indicate the identity, signal metric, or number of network nodes, relay radio devices, cells, or beams providing the direct coverage, indirect coverage, or lacking coverage.

It is worth noting that each module may handle multiple steps mentioned in the first method aspect. The module that is most appropriate for each step may perform it, ensuring that the device operates efficiently and effectively.

Alternatively or in addition, the device 100 comprises at least one of the modules 102, 104, and 106 indicated in FIG. 1 for performing the steps 402, 404, and 406 of the first method aspect, respectively.

Any of the modules of the device 100 may be implemented by units configured to provide the corresponding functionality.

The device 100 may also be referred to as, or may be embodied by, the radio device (or briefly: UE). The radio device 100 and the RAN may be in direct or indirect radio communication, e.g., at least for exchanging the disclosed messages.

FIG. 2 schematically illustrates a block diagram of an embodiment of a device according to the second device aspect. The device is generically referred to by reference sign 200.

The device 200, which may be a relay radio device, plays an integral role in facilitating indirect communication with a radio access network (RAN). One of the key features of device 200 is its Report Forward Module 206. This module is responsible for receiving a report message from a companion radio device 100, which may operate beyond the direct coverage of a RAN. The report message provides valuable input related to the coverage status of radio device 100 in relation to the RAN, essentially indicating whether radio device 100 is capable of accessing the RAN through indirect means, such as via one or more other relay radio devices, like device 200. Once the report message is effectively obtained, the Report Forward Module 206 shoulders the responsibility of transmitting this message to a first network node within the RAN.

In certain scenarios, device 200 can also include a Status Forward Module 202. This optional module can further refine the communication process by forwarding a status message from radio device 100 to the RAN. A feature which can provide the RAN with additional context about the operational status and reach of radio device 100.

Furthermore, device 200 can optionally feature a Request Forward Module 204. The primary function of this module can potentially involve transmitting or forwarding a request or a configuration message to radio device 100. It serves as an optional intermediary that can help define the parameters of the report message or establish configurations for reporting the coverage status of radio device 100. This feature can be particularly useful when the status message necessitates a response.

Alternatively or in addition, the device 200 comprises at least one of the modules 202, 204, and 206 that perform the steps 502, 504, and 506 of the second method aspect, respectively.

Any of the modules of the device 200 may be implemented by units configured to provide the corresponding functionality.

The device 200 may also be referred to as, or may be embodied by, any one of the one or more relay radio device (or briefly: relays). The relay radio device 200 and the RAN or its network nodes 300 and/or the radio device 100 may be in direct radio communication, e.g., at least for the forwarding of the disclosed messages.

FIG. 3 schematically illustrates a block diagram of an embodiment of a device according to the third device aspect. The device is generically referred to by reference sign 300.

The device 300, e.g. a network node associated with a radio access network (RAN), plays a critical role in coordinating network coverage and managing radio devices.

The device 300, which may be a first network node of the RAN, operates as a critical component driving vital communications with a radio device 100, directly or indirectly through one or more relay devices 200. This interaction is carried out through one or several modules within the device 300.

Starting with the Status Reception Module 302, this feature can optionally receive a status message from the radio device 100. This process enables it to understand one or more time spans and locations where information about the coverage status of the radio device 100 relative to the RAN is available. Such capability enhances the level of communication with the radio device 100 and may influence the radio device's subsequent network communications.

Request Transmission Module 304 plays an essential role in transmitting a request message to the radio device 100. This request message potentially guides the radio device 100 on specific time spans and locations for which the coverage status relative to the RAN must be reported. This targeted approach to communication support can directly influence the efficacy of the transmitted report message from the radio device 100.

Moreover, the mandatory Report Reception Module 306 receives a report message from the radio device 100. This report message signals the coverage status of the radio device 100 relative to the RAN, which may include details of an indirect coverage of the RAN through one or more relay devices 200. This module represents a crucial link in the communication chain between the radio device's network coverage capacity and the network itself.

In addition to the functionalities of these specific modules, other steps of the third method aspect may also be optionally performed by one of the modules most suited for the step. Fundamentally, the device 300, through its diverse components, provides a robust and flexible framework to facilitate and optimize radio network communications.

Alternatively or in addition, the device 300 comprises at least one of the modules 302, 304, and 306 that perform the steps 602, 604, and 606 of the third method aspect, respectively.

Any of the modules of the device 300 may be implemented by units configured to provide the corresponding functionality.

The device 300 may also be referred to as, or may be embodied by, any one of the network nodes of the RAN, e.g., the first network node (or briefly: gNB). The first network node 300 may be in direct radio communication with the relay radio device, and/or in direct or indirect radio communication with the radio device 100, e.g., at least for the exchanging of the disclosed messages.

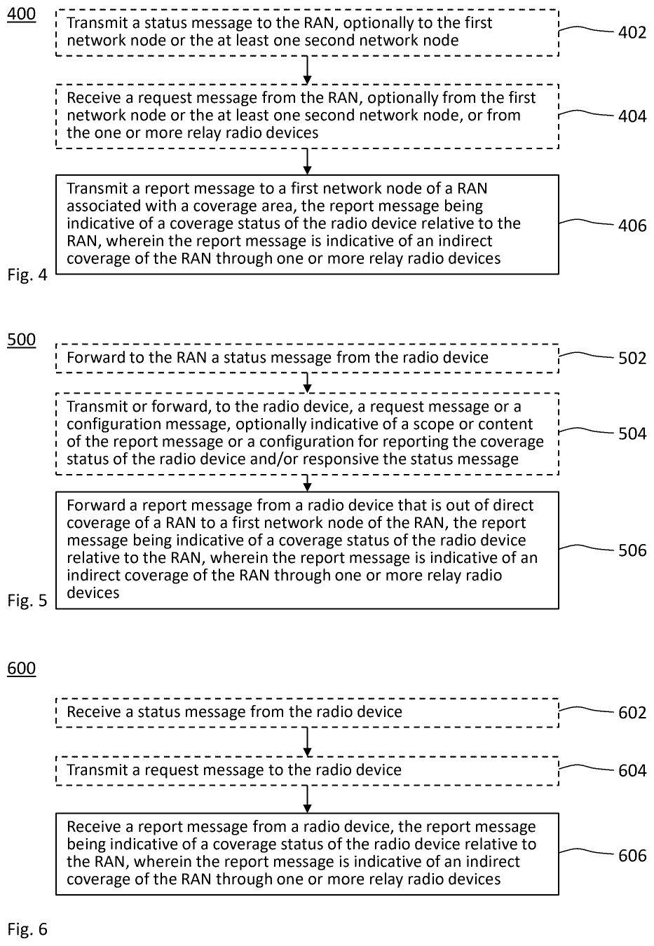

FIG. 4 shows an example flowchart for a method 400 according to the first method aspect. Alternatively or in addition, the method may comprise at least one of the steps indicated in FIG. 4.

The method 400 may be performed by the device 100. For example, the modules 102, 104 and 106 may perform the steps 402, 404 and 406, respectively.

FIG. 5 shows an example flowchart for a method 500 according to the second method aspect. Alternatively or in addition, the method may comprise at least one of the steps indicated in FIG. 5.

The method 500 may be performed by the device 200. For example, the modules 202, 204 and 206 may perform the steps 502, 504 and 506, respectively.

FIG. 6 shows an example flowchart for a method 600 according to the second method aspect. Alternatively or in addition, the method may comprise at least one of the steps indicated in FIG. 6.

The method 600 may be performed by the device 300. For example, the modules 302, 304 and 306 may perform the steps 602, 604 and 606, respectively.

Herein, 300-i, 300-d, and 300-o may be instances of an embodiment of the first network node and/or any one of the at least one second network node providing indirect, direct, or no coverage of the radio device 100. Hereinbelow, the reference sign 300 denotes any network node of the RAN.

In any aspect, the technique may be applied to uplink (UL), downlink (DL) or direct communications between radio devices, e.g., device-to-device (D2D) communications or sidelink (SL) communications.

Each of the radio device 100, relay radio device 200, the first network node 300 and the at least one second network node 300 may be a radio device or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

For concreteness and without limitation, the radio devices are referred to UEs hereinbelow.

Any embodiment of any method aspect of the technique may be, or may comprise, a method for how the UE logs (e.g., stores locally) and reports (e.g., according to the step 406) being in-coverage and/or being out-of-coverage on Uu link and/or a (e.g., sidelink) relay. For example, the status message may indicate information about, and/or the report message may be indicative of, and/or the configuration message may configure the UE 100 to report 406, and/or the request message may request the UE 100 to report 406 at least one of the following items:

A first item comprises the time spent (also referred to as a “time span”) by the UE 100 in-coverage of a sidelink relay 200, e.g., while being in-coverage of any Uu cell

Herein, being coverage of a Uu cell may encompass being connected to a certain Uu primary cell (Pcell) and optionally a primary secondary cell group (SCG) cell (PSCell), or camping on a certain Uu cell.

A second item comprises the time spent by the UE 100 in-coverage of a sidelink relay 200, while being not in coverage of any Uu cell.

A third item comprises the time spent by the UE 100 not in coverage of any sidelink relay 200, while being in-coverage of any Uu cell (i.e. connected to a certain Uu Pcell and optionally PSCell, or camping on a certain Uu cell).

A fourth item comprises the time spent by the UE 100 not in coverage of any sidelink relay 200, while being not in coverage of any Uu cell, wherein the time spent by the UE in-coverage of a sidelink relay is the time spent with a specific sidelink relay coverage since discovering the UE 100, while connected to a certain Uu cell, or while being in out-of Uu coverage.

Alternatively or in addition, the time spent by the UE 100 not in-coverage of a sidelink relay is the time spent with no relay coverage since exiting the sidelink coverage while connected to a certain Uu cell, or while being in out-of Uu coverage.

Additionally, the UE 100 may log (e.g., store locally at the UE 100) at least one of:
The identity (ID), e.g. a cell radio network temporary identifier (C-RNTI), and/or an L1 ID (e.g. ID PHY layer) or L2 ID (e.g., a medium access control, MAC, ID) of the sidelink relay 200 that is providing coverage to the UE 100.
The frequency in which the discovered sidelink relay 200 is operating.
The cell in which the discovered sidelink relay is operating. This information may require the UE 100 deriving this information from the sidelink radio resource control (SL RRC) signaling transmitted by the sidelink relay 200.
An indication indicating whether the UE 100 is connected (i.e., an SL RRC connection is established) to the sidelink relay 200 that is providing coverage (i.e., the indirect coverage), or whether the said sidelink relay 200 has been discovered by the UE 100, but not connected yet.
The time spent by the UE 100 while being connected (i.e. an SL RRC connection is established) to the sidelink relay 200.
An indication indicating whether the UE 100 is capable of sidelink communication, i.e. it is capable of connecting to the sidelink relay.
An indication indicating the amount (e.g., a number or areal density) of sidelink relay UEs 200 that are in coverage at a given point in time. In another embodiment or variant, whenever logging a sidelink relay UE 200 in the list of discovered sidelink relay UEs 200 (e.g., the information available as to indirect coverage), the UE 100 may indicate whether the newly added sidelink relay UE 200 was discovered while one or more of the previously logged sidelink relay UE 200 was still in coverage.

In one embodiment or variant, the above information are stored by the UE 100 in the VarMobilityHistoryReport according to the mobility history information (MHI) framework (also referred to as MHI reporting).

Any embodiment may implement, or enhance, at least one of the following features and steps of Mobility History Information (MHI) reporting, e.g. for an implementation of the step 406.

Mobility history information (MHI) has been introduced in 3GPP Long Term Evolution (LTE) and has been adopted in 3GPP New Radio (NR) as well. The MHI measurements are accumulated by the UE 100 independent of its RRC state (which may include idle, inactive, and connected). As part of the MHI, the UE 100 stores the cell identifier which is the current serving cell for this UE, i.e. the PCell for UEs in connected mode, or the cell in which the UE is camping in idle and/or inactive mode, and also stores the information related to how long the UE 100 has stayed in this cell. The UE 100 further keeps such a history for up to past 16 serving cells. The UE 100 also includes information related to how long it has been out of the coverage scenario as well.

In particular, in NR, upon change of suitable cell consisting of PCell in RRC_CONNECTED or serving cell in RRC_INACTIVE (for NR cell) or in RRC_IDLE (for NR or E-UTRA cell), to another NR or E-UTRA cell, or when entering any cell selection′ state from ‘camped normally’ state in NR or LTE, the UE includes the global cell identity (if available) of that cell in the field visitedCellld of VarMobilityHistoryReport. Otherwise if the global cell identity of that cell is not available, the UE includes the physical cell identity and carrier frequency of that cell in the field visitedCellld of VarMobilityHistoryReport. Additionally, the UE sets the time spent in the previous PCell/serving cell in the VisitedCellInfo of VarMobilityHistoryReport.

Similarly related to transitions from out-of-coverage to in-coverage, it is specified that upon entering NR (in RRC_IDLE, RRC_INACTIVE or RRC_CONNECTED) or E-UTRA (in RRC_IDLE or RRC_CONNECTED) while previously in ‘any cell selection’ state or ‘camped on any cell’ state in NR or LTE, the UE sets the field timeSpent to the the time spent in ‘any cell selection’ state and/or ‘camped on any cell’ state in NR or LTE in the VisitedCellInfo of VarMobilityHistoryReport.

The UE 100 can indicate the availability of this mobility history via the field mobilityHistoryAvail in either RRCSetupComplete or RRCResumeComplete messages, and then include the stored MHI information in the MobilityHistoryReport if requested by the network. It is the RAT of the fetching cell that implicitly decides whether the UE will report the LTE-MHI or the NR-LTE MHI. The network can also propagate the received MHI between network nodes upon handover of the UE.

Based on the MHI reported by the UE, the network can estimate the UE mobility characteristics like UE speed. This reporting can also help the network operator to optimize the network and address coverage holes. For example, if the operator determines that in a certain part of the network UEs are experiencing out-of-coverage, the operator may add a cell that covers that area. Such reporting is done using the RRC protocol where the UE logs the in-/out-of-coverage times. When the UE connects to the network the UE can indicate to the network that the UE has such reports available.

Since 3GPP Release 17, it is also possible for the UE to log into the MHI not only the visited Pcell but also the visited PSCell(s) while connected to a certain Pcell, as well as the time spent while connected to a certain PSCell, or the time spent without any PSCell (meaning no dual-connectivity configured). This new functionality might be beneficial both for the MN and SN. The MN for example can use this information to understand the coverage of the SN and based on this enable faster DC setup, e.g. the MN can figure out that a certain cell has good performances if the time spent was high. On the other hand, the SN can use this information to enable a more efficient SN change in the “SN initiated change” framework, e.g. the SN can suggest the PCell another PSCell which is supposed to provide good performances.

Any embodiment of any aspect may use at least one of the following features or steps of sidelink (SL) transmissions in NR, e.g., for transmitting any one of the messages disclosed herein between the UE 100 and the relay UE 200.

Sidelink transmissions over NR are specified since 3GPP Release 16. These are enhancements of the ProSe (PROximity-based SErvices) specified for LTE. Four enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a changed design of physical SL control channel (PSCCH).
To achieve a high connection density, congestion control and thus the quality of service (QOS) management is supported in NR sidelink transmissions.

To enable the above enhancements, specific physical channels and reference signals are used in NR (some of which are available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitting the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSI-RS): These physical reference signals supported by NR downlink/uplink transmissions are also adopted by sidelink transmissions. Similarly, the PT-RS is only applicable for FR2 transmission.

Another feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for ProSe in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the (conventionally “in-coverage”) UE 100 (i.e., when the UE 100 is in direct coverage of the RAN), a gNB 300 can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE 100 launches the PSCCH, cyclic redundancy check (CRC) is also inserted in the SCI without any scrambling.

In the Mode 2 resource allocation, when traffic arrives at a transmitter UE 100, this transmitter UE 100 should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for at least one of the following transmissions: Firstly, the PSSCH associated with the PSCCH for initial transmission and blind retransmissions. Secondly, the PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

The indirect coverage may use a Layer 2 (L2) UE-to-Network relay 200.

In the 3GPP document TR 23.752, clause 6.7, version 17.0.0, the layer-2 based UE-to-Network relay is described.

Any embodiment of any aspect may implement at least one feature of the following general information for using an L2 relay UE 200.

In this clause, the protocol architecture supporting a L2 UE-to-Network Relay UE 200 (briefly: L2 relay UE) is provided.

The L2 UE-to-Network Relay UE 200 provides forwarding functionality that can relay any type of traffic over the PC5 link.

The L2 UE-to-Network Relay UE 200 provides the functionality to support connectivity to the fifth-generation system (5GS) for Remote UEs. A UE 100 is considered to be a Remote UE if it has successfully established a PC5 link to the L2 UE-to-Network Relay UE. A Remote UE 100 can be located within NG-RAN coverage or outside of NG-RAN coverage.

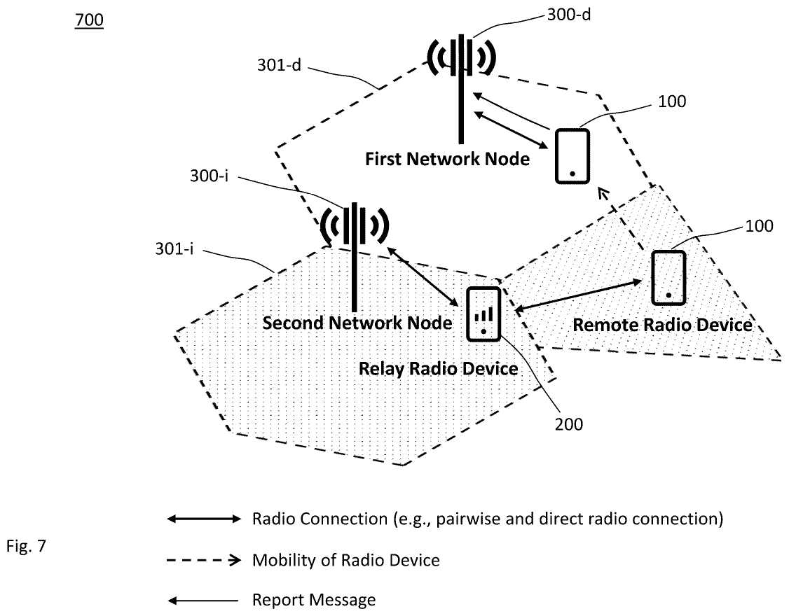

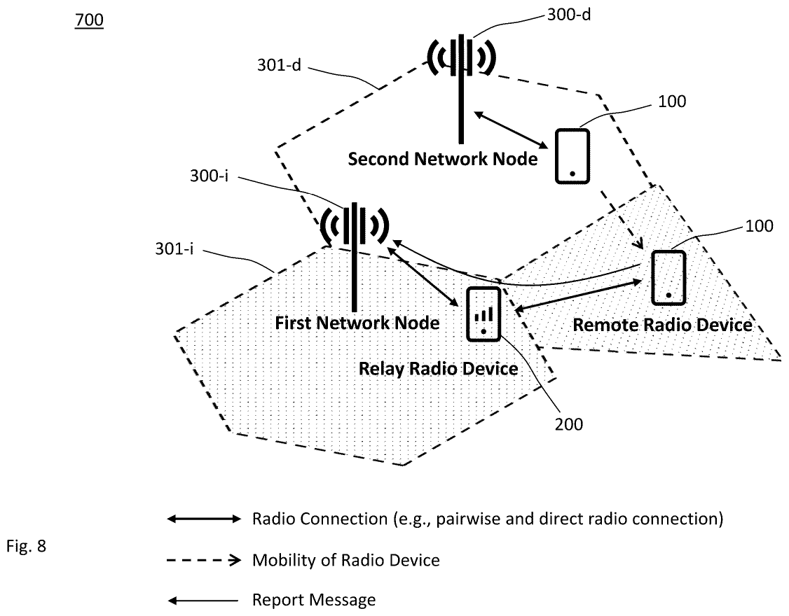

FIGS. 7 and 8 schematically illustrates first and second examples, respectively, of an RAN 700 comprising embodiments of the UE 100, the relay UE 200 and the first and second network nodes 300 for performing the methods 400, 500, and 600, respectively.

In the case of FIG. 7, the UE 100 is a remote UE 100 in a first time span and move to direct coverage in a second time span. Upon arrival in the direct coverage, the report message is transmitted to the first network node 300-d.

In the case of FIG. 8, the UE 100 is a UE 100 in direct coverage in a first time span and move to indirect coverage in a second time span. Upon arrival in the indirect coverage, the report message is transmitted to the first network node 300-i through the relay UE 200.

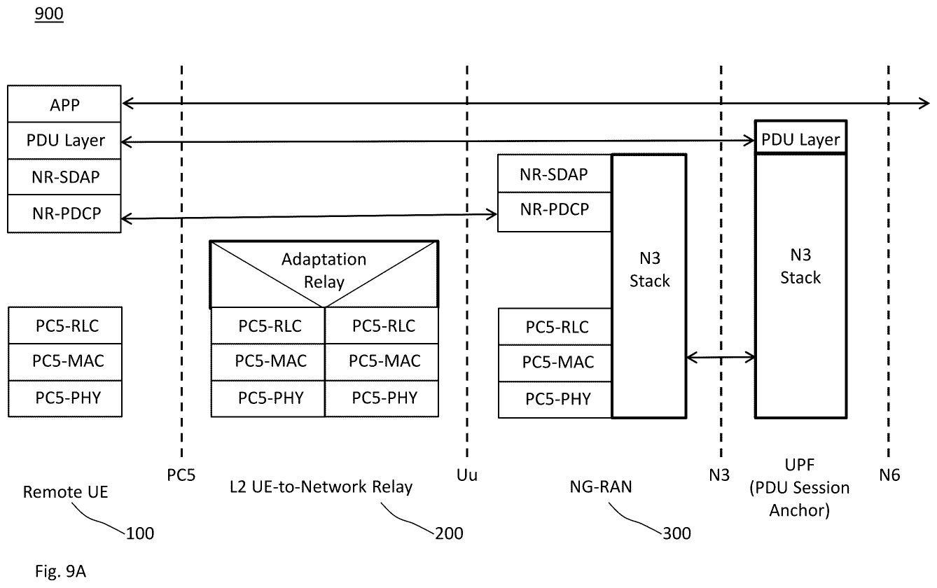

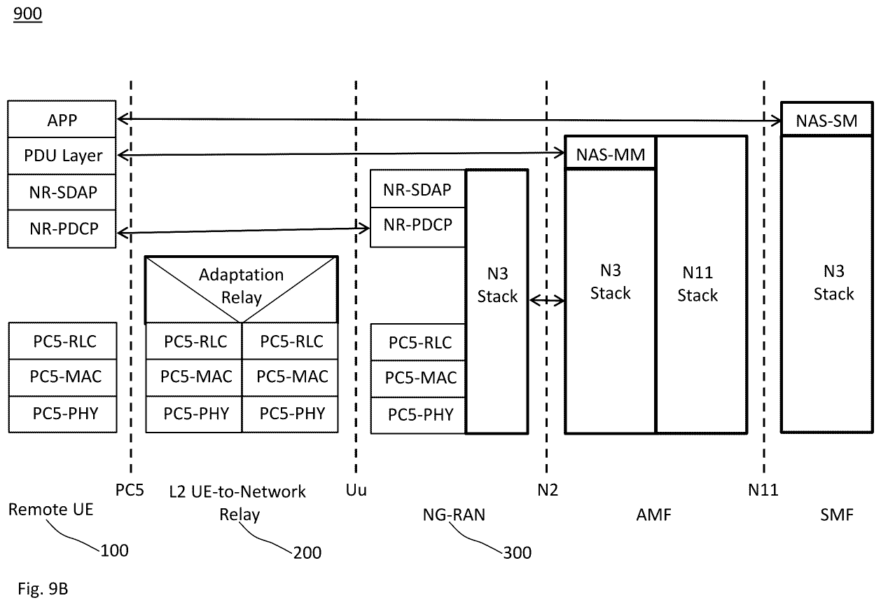

FIG. 9A illustrates the protocol stack for the user plane transport, related to a PDU Session, including a Layer 2 UE-to-Network Relay UE 200. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE 100 and the gNB 300-i without exposing raw data at the UE-to-Network Relay UE 200.

A protocol stack for a User Plane (UP) of an L2 UE-to-Network Relay UE (i.e., the relay radio device 200 performing the relaying on Layer 2) may be implemented according to FIG. 9A and/or the Figure A.2.1-1 of the 3GPP document TR 23.752, version

The adaptation relay layer within the UE-to-Network Relay UE can differentiate between signaling radio bearers (SRBs) and data radio bearers (DRBs) for a particular Remote UE. The adaption relay layer is also responsible for mapping PC5 traffic to one or more data radio bearers (DRBs) of the Uu. The definition of the adaptation relay layer is under the responsibility of RAN WG2.

FIG. 9B illustrates the protocol stack of the NAS connection for the Remote UE 100 to the NAS-MM and NAS-SM components. The NAS messages are transparently transferred between the Remote UE and 5G-AN over the Layer 2 UE-to-Network Relay UE 200 using:
PDCP end-to-end connection where the role of the UE-to-Network Relay UE 200 is to relay the PDUs over the signaling radio bear without any modifications.
N2 connection between the 5G-AN and AMF over N2.
N3 connection AMF and SMF over N11.

The role of the UE-to-Network Relay UE 200 is to relay the PDUs from the signaling radio bearer without any modifications.

A protocol stack of a Control Plane (CP) of an L2 UE-to-Network Relay UE 200 (i.e., an embodiment of the relay radio device 200 performing the relying between the radio device 100 to the RAN on Layer 2) may be implemented according to FIG. 9B or the Figure A.2.2-1 in the 3GPP TR 23.752, version 17.0.0.

Any embodiment of any aspect may perform at least one of the following steps of a relay establishment procedure.

The Remote UE 100 (i.e., the UE 100 in the indirect coverage) needs to establish its own PDU sessions and/or one or more DRBs with the network (e.g., a core network serving the respective network node 300-i) before performing a user plane data transmission.

PC5-RRC aspects of Rel-16 NR V2X PC5 unicast link establishment procedures can be reused to setup a secure unicast link between Remote UE and Relay UE for L2 UE-to-Network relaying before Remote UE establishes a Uu RRC connection with the network via Relay UE.

For both in-coverage and out-of-coverage cases, when the Remote UE initiates the first RRC message for its connection establishment with gNB, the PC5 L2 configuration for the transmission between the Remote UE and the UE-to-Network Relay UE can be based on the RLC/MAC configuration defined in specifications. The establishment of Uu SRB1/SRB2 and DRB of the Remote UE is subject to legacy Uu configuration procedures for L2 UE-to-Network Relay.

The following high level connection establishment procedure applies to L2 UE-to-Network Relay:

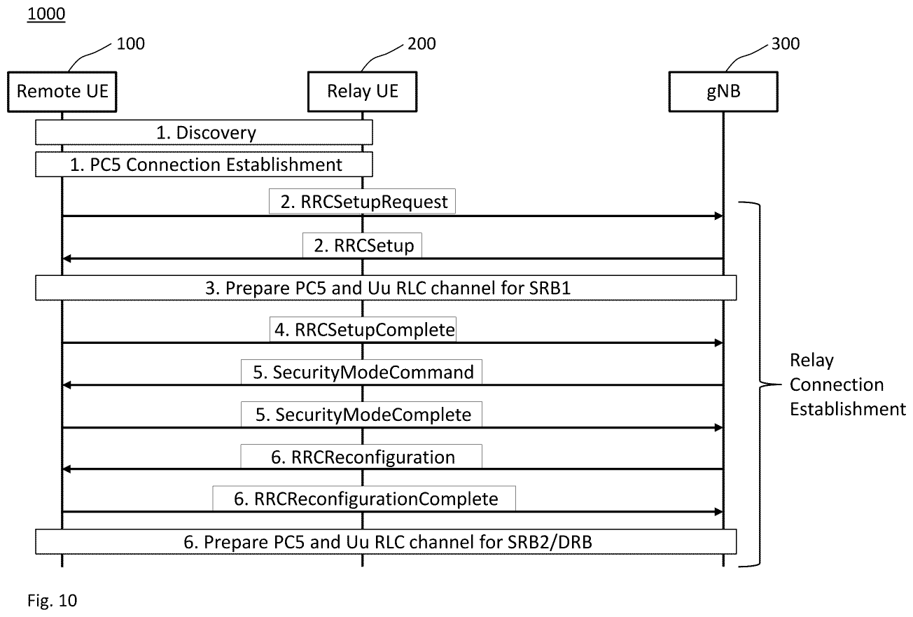

An embodiment of the remote UE 100 may perform a procedure for connection establishment according to FIG. 10 and/or the FIG. 4.5.5.1-1 in the 3GPP document TR 38.836, version 17.0.0. The procedure may comprise at least one of the following steps.

Step 1. The Remote and Relay UE perform discovery procedure, and establish PC5-RRC connection using the legacy Rel-16 procedure as a baseline.

Step 2. The Remote UE sends the first RRC message (i.e., RRCSetupRequest) for its connection establishment with gNB via the Relay UE, using a default L2 configuration on PC5. The gNB responds with an RRCSetup message to Remote UE. The RRCSetup delivery to the Remote UE uses the default configuration on PC5. If the relay UE had not started in RRC_CONNECTED, it would need to do its own connection establishment as part of this step. The details for Relay UE to forward the RRCSetupRequest/RRCSetup message for Remote UE 100 at this step can be discussed in a work item (WI) phase.

Step 3. The gNB and Relay UE perform relaying channel setup procedure over Uu. According to the configuration from gNB, the Relay/Remote UE establishes an RLC channel for relaying of SRB1 towards the Remote UE over PC5. This step prepares the relaying channel for SRB1.

Step 4. Remote UE SRB1 message (e.g. an RRCSetupComplete message) is sent to the gNB via the Relay UE using SRB1 relaying channel over PC5. Then the Remote UE is RRC connected over Uu.

Step 5. The Remote UE and gNB establish security following legacy procedure and the security messages are forwarded through the Relay UE 200.

Step 6. The gNB sets up additional RLC channels between the gNB and Relay UE 200 for traffic relaying. According to the configuration from gNB, the Relay/Remote UE sets up additional RLC channels between the Remote UE and Relay UE 200 for traffic relaying. The gNB sends an RRCReconfiguration to the Remote UE via the Relay UE, to set up the relaying signaling radio bearer (e.g., SRB2) and/or one or more DRBs. The Remote UE 100 transmits an RRCReconfigurationComplete to the gNB 300-i via the Relay UE 200 as a response.

The methods and solutions disclosed in the following, are referring to the NR as an exemplary radio access technology (RAT) and can be applied also to LTE RAT and any other RAT (e.g., Wi-Fi) enabling the direct transmission between two (or more) nearby devices without any loss of meaning.

In the following, with “relay” or “sidelink relay”, we refer to a communication that is generated by a remote UE and is terminated at a gNB (or another destination remote UE) via the use of an intermediate node called relay UE.

Further, we refer to RM UE as the remote UE that needs to transmit/receive packet from/to the gNB or another UE (called target remote UE) via an intermediate mobile terminal (relay) that we refer to as RL UE.

In the following, the terms “relay link”, “PC5 link”, “sidelink relay link” but those can be used interchangeably without any loss of meaning.

Any embodiment of any aspect may apply one or more of the following definitions of in- and out-of-coverage.

The technique may be embodied to control how the UE 100 logs and reports times related to being in/out of coverage with regards to a Uu link and a relay link (e.g., a Sidelink relay link).

In one embodiment or variant of any embodiment, the time spent by the UE 100 in-coverage of a sidelink relay UE 200 may be the overall time since the UE discovers this sidelink relay 200 until the radio quality of the sidelink drops below a certain threshold.

The UE 100 may determine itself to be out of coverage on a (sidelink) relay link as the time when the UE 100 does not discover any candidate relay. A relay may be considered a candidate if that relay could (potentially) provide connectivity for the UE. And the UE considers itself to be in coverage if the UE discovers a candidate relay. Further being connected to may also be considered as being in coverage.

Furthermore, the UE 100 considers itself to be out of coverage if no relays are discovered and no cells are detected. On the contrary, the UE considers itself to be in-coverage if at least one between a relay or a cell is discovered/detected by the UE.

Another approach is that the UE 100 considers itself to be in coverage or out of coverage on a link (Uu or relay), if a signal metric associated with a link is above or below a threshold, respectively. For example a measured signal strength or quality metric is below a threshold and the UE 100 considers itself to be out of coverage and in coverage if the signal strength or quality metric is above a threshold.

The thresholds may be configurable by the network or preconfigured or specified in a specification. The UE may apply different thresholds for determining itself to be out of coverage on a Uu link compared to the threshold used for determining itself to be out of coverage on a relay link.

For example, in one embodiment, the time spent by the UE in-coverage of a sidelink relay UE may be the overall time since the UE discovers the said sidelink relay until the radio quality of the sidelink drops below a certain threshold. In another spent while connected to the said sidelink relay UE.

In another embodiment or another variant of any embodiment, the time spent while connected to the said sidelink relay UE (i.e. an SL RRC connection is established) is logged separately from the time spent by the UE 100 in-coverage of the sidelink relay UE 200.

The repot message may comprise, and/or the UE 100 may store (e.g., may be logging) at least one of the following metrics.

Herein, “time” may refer to a timestamp and/or a timespan (herein also spelled time span).

The UE 100 may log and/or report to the network 700 and/or the first network node 300 one or more of:
A first time when the UE is out of coverage with respect to the Uu connectivity.
A second time when the UE is in of coverage with respect to the Uu connectivity.
A third time when the UE is out of coverage with respect to the relay connectivity.
A fourth time when the UE is in coverage with respect to the relay connectivity.
A fifth time when the UE is in coverage of a relay while being in coverage of a certain (Uu) cell C. For example, the UE logs the time that the UE was in coverage of a relay X, while the UE was in coverage of the cell C. The UE may indicate multiple relays that the UE was in coverage of while being connected to cell C, and for each of the said multiple relay the corresponding time spent while in coverage of a given relay. These multiple relays may be indicated as a list in the report. In case the UE has not been in coverage of any relay while being in coverage of cell C, the UE may report it as an empty field or list, or it may indicate the time spent with no coverage of any sidelink relay.
A sixth time when the UE is out of coverage with respect to the Uu connectivity and out of coverage with respect to the relay connectivity. This time could be understood as a time when the UE has no access at all (not via Uu and not via a relay) to the network.
The number of relays that the UE has been in coverage of. The UE may log and report this in relation to a Uu connectivity, for example the UE may log the number of relays the UE was in coverage of while being connected to a certain (Uu) cell. This may be indicated as a number. Another approach is that the UE indicates the identities for the relays that the UE has been in coverage of.
A eight time describing for how long a UE has been in-coverage with a certain relay. This mean that the UE may report multiple timers, one for each relay discovered.
A ninth time describing for how long a UE has been in-coverage with a certain cell. This mean that the UE may report multiple timers, one for each cell discovered.
The frequency in which the discovered sidelink relay is operating
The cell in which the discovered sidelink relay is operating. This information may require the said UE deriving this information from the SL RRC signaling transmitted by the sidelink relay
An indication indicating whether the said UE is connected (i.e. an SL RRC connection is established) to the said sidelink relay that is providing coverage, or whether the said sidelink relay has been discovered by the said UE, but not connected yet.
The time spent by the UE while being connected (i.e. an SL RRC Connection is established) to the said sidelink relay.
An indication indicating whether the UE is capable of sidelink communication, i.e. it is capable of connecting to the sidelink relay
An indication for each logged sidelink relay UE indicating if at the moment of discovering the newly logged sidelink relay UE, the UE was still in coverage of one or more specific other sidelink relay UEs that were previously logged. The UE may also add a further time indicator indicating how much time has elapsed between the discovery of the newly logged sidelink relay UE and the previously discovered sidelink relay UE.

In the above, it has been described how the UE 100 logs when the UE is in-coverage of a relay connection (e.g., in indirect coverage). The UE 100 may in addition to that log information regarding the relay connection, for example at least one of:
signal related metrics, e.g., signal strength and/or quality and/or which frequency was used;
information related to the type of relay connection; and
identities related to the relay 200 or relay connection.

Any one or each of the steps 406, 506, and 606 for the transmitting of logged information to the network 700, e.g., to the first network node 300, may comprise at least one of the following steps or features.

The UE 100 may transmit 406 the logged information to the network 700 (e.g., the first network node 300). This may be signaled using an RRC message.

The UE 100 may indicate to a network that the UE 100 has logs (i.e., stored information) of the above times available. The UE may transmit (e.g., according to the step 402) a separate availability-indications (e.g., in the status message) for the different logged times. Alternatively, the UE 100 may indicate that it has logged times which comprises that the UE 100 has any of these times available.

In response to that, the UE 100 indicates that the UE 100 has logs of these times available, the network may request (e.g., in the step 604 using the request message) the UE 100 to transmit (in the step 406) these times. The request may be independent for the different times. Alternatively, there may be one request per time, allowing the network to choose which of the times the network wants the UE to transmit in the step 406.

The UE 100, acting as remote UE, may also indicate to the relay UE 200 (with whom the remote UE 100 is connected) that the remote UE 100 has logs of the above times available (e.g., according to the step 502).

In this case or in another embodiment, upon receiving this indication from the remote UE 100, the relay UE 200 may in a first variant request this information from the remote UE 200 and later forwards the information (e.g., logs) to the network 700 (e.g., together or not with other logs collected by the relay UE 200). In a second variant, the relay UE 200 may transmit another indication to the network 700 (e.g., the first network node 300) to inform that the remote UE 100 has information (e.g., logs) for the above times available.

In response to the indication of relay UE 200 (e.g., according to the step 602) that the remote UE 100 has information (e.g., logs) available for the above timers, the network 700 (e.g., the first network node 300) may either transmit a request directly to the remote UE (via the relay UE) (e.g., according to the step 604) or may transmit a request for the information (e.g., logs) of the remote UE 100 to the relay UE 200, and then the relay UE 200 transmits this request to the remote UE (e.g., according to the step 504). The request may be independent for the different times. Alternatively, there may be one request per time, allowing the network to choose which of the times the network wants the UE 100 to transmit.

As a further alternative, the UE 100 may transmit the logged (e.g., stored) information to the network (i.e., without waiting for an explicit request from the network) every time that a new relay connection is established or released. Yet, in another alternative, the UE 100 may transmit the logged information to the network (i.e., without waiting for an explicit request from the network) every time that a new relay is discovered and selected as relay for the relay connection.

The aforementioned information related to the sidelink information and reported to the network as per the above methods, can be used by the network to analyze the Uu coverage with respect to the SL coverage. For example:
If it is determine that a certain sidelink relay offers coverage to the said UE and the time spent with SL coverage is high, both when the said UE is in Uu coverage and out-of Uu coverage, the network may early provide a SL configuration to the said UE to enable communication with the certain sidelink relay, thereby minimizing service interruption time when exiting the Uu coverage
If it is determined that the time spent with SL coverage, while the UE is connected/camping in a certain Uu cell, is low while the time spent with Uu coverage in a certain cell is high, the network may determine to not provide a SL configuration to the said UE.
If it is determined that the time spent with SL coverage while the UE is connected/camping in a certain Uu cell is high, while also the time spent with Uu coverage in a certain cell is high, the network may determine to provide a SL configuration to the said UE for Uu off-loading purposes for example, or for low-priority traffic.
If it is determined that the time spent with SL coverage while the UE is configured with DC (i.e. the UE includes in the MHI the PCell and the PSCell) is high, the network may not configure the UE with DC, in case it is needed to avoid configuring DC across nodes, or for low priority traffic.
If it is determined that the time spent with SL coverage while the UE is configured with DC (i.e. the UE includes in the MHI the PCell and the PSCell) is low, the network may instead downprioritize SL configuration with respect to DC configuration
The network can derive the capillarity of the sidelink relay network coverage, and if there is any overlapping on the coverage provided by multiple sidelink relay UEs. This can be derived from the indication for each logged sidelink relay UE about whether at the moment of discovering the newly logged sidelink relay UE, the UE was still in coverage of one or more specific other sidelink relay UEs that were previously logged. Or from the time indicator indicating how much time has elapsed between the discovery of the newly logged sidelink relay UE and the previously discovered sidelink relay UE, so that the network can understand if there was any gap on the sidelink relay coverage provided by different sidelink relay UEs. This information can also be used by the network to distribute more or less sidelink relay UEs in the network.

The above embodiments of the method 400 (i.e., UE methods) may be represented, by way of example, as follows in an enhancement of a technical specification (e.g., according to the bold type text in the below excerpt from the 3GPP document TS 38.331). For example, the report message may be included in, or implemented using, the VisitedCellInfoList within the VarMobilityHistoryReport.

For example, the UE 100 appends in a structure (e.g., in terms of an Abstract Syntax Notation One, ASN.1) all the sidelink relay UEs 200 in the discoveredSLRelaysList-rxy that were discovered while connected or camping in the serving cell identified in visitedCellId. The sidelink relay UEs in the discoveredSLRelaysList-rxy are included in the order of discovered sidelink relay UEs. Each entry of the discoveredSLRelaysList-rxy includes a plurality of information associated to a given discovered sidelink relay UEs 200, and the time spent connected to the said sidelink relay UE 200. If a given point in time, the UE does not have any sidelink relay coverage while connected to the Uu serving cell, it appends in the discoveredSLRelaysList-rxy an entry with no information associated to any sidelink relay UE 200, except the time spent with no sidelink relay coverage.

In case the UE 100 changes Uu cell (e.g. after an HO, or upon cell reselection), while still being in-coverage of the same sidelink relay UE 200, the UE 100 may append under the newly added entry associated to the new Uu cell, once more the information associated to such same sidelink relay UE. In one embodiment, in this case, the time spent under the coverage of such sidelink relay is started from the time the UE connects to the new Uu cell, whereas in another embodiment, the time spent is the overall time the UE has been under the coverage of the concerned sidelink relay considering also the time in which the UE was connected/camping under previous Uu cell.

Any embodiment of any aspect may implement one or more features of the following VisitedCellInfoList.

The information element (IE) VisitedCellinfoList includes the mobility history information of maximum of 16 most recently visited primary cells or time spent in any cell selection state and/or camped on any cell state in NR or E-UTRA and, in case of Dual Connectivity, the mobility history information of maxPSCellHistory most recently visited primary secondary cell group cells across all the primary cells included in the VisitedCellInfoList, and, for a sidelink capable UE, the mobility history information of maxSLRelayHistory most recently discovered sidelink relays. The most recently visited cell or discovered relays is stored first in the list. The list includes cells visited in RRC_IDLE, RRC_INACTIVE and RRC_CONNECTED states for NR and RRC_IDLE and RRC_CONNECTED for E-UTRA.

### VisitedCellInfoList Information Element

-- ASN1START
-- TAG-VISITEDCELLINFOLIST-START
VisitedCellInfoList-r16 ::= SEQUENCE (SIZE (1..maxCellHistory-r16)) OF
VisitedCellInfo-r16

| | |
|---|---|
| VisitedCellInfo-r16 ::= | SEQUENCE { |
| visitedCellId-r16 | CHOICE { |
| nr-CellId-r16 | CHOICE { |
| cgi-Info | CGI-Info-Logging-r16, |
| pci-arfcn-r16 | PCI-ARFCN-NR-r16 |

},

| | |
|---|---|
| eutra-CellId-r16 | CHOICE { |
| cellGlobalId-r16 | CGI-InfoEUTRA, |
| pci-arfcn-r16 | PCI-ARFCN-EUTRA-r16 |

}

| | |
|---|---|
| } | OPTIONAL, |
| timeSpent-r16 | INTEGER (0..4095), |

```
    ...,
    [[
```

| | |
|---|---|
| visitedPSCellInfoList-r17 | VisitedPSCellInfoList-r17 |

```
OPTIONAL
    ]],
  [[
```

| | |
|---|---|
| discoveredSLRelaysList-rxy | DiscoveredSLRelaysInfoList- |

rxy OPTIONAL
]]
}
VisitedPSCellInfoList-r17 ::= SEQUENCE (SIZE (1..maxPSCellHistory-r17))
OF VisitedPSCellInfo-r17
DiscoveredSLRelaysInfoList-rxy ::= SEQUENCE (SIZE (1..maxSLRelayHistory-
rxy)) OF DiscoveredSLRelaysInfo-rxy

| | |
|---|---|
| VisitedPSCellInfo-r17 ::= | SEQUENCE { |
| visitedCellId-r17 | CHOICE { |
| nr-CellId-r17 | CHOICE { |
| cgi-Info-r17 | CGI-Info-Logging-r16, |
| pci-arfcn-r17 | SEQUENCE { |
| physCellId-r17 | PhysCellId, |
| carrierFreq-r17 | ARFCN-ValueNR |

```
        }
      },
```

| | |
|---|---|
| eutra-CellId-r17 | CHOICE { |
| cellGlobalId-r17 | CGI-InfoEUTRALogging, |
| pci-arfcn-r17 | SEQUENCE { |
| physCellId-r17 | EUTRA-PhysCellId, |
| carrierFreq-r17 | ARFCN-ValueEUTRA |

```
        }
      }
```

| | |
|---|---|
| } | OPTIONAL, |
| timeSpent-r17 | INTEGER (0..4095), |

...
}

| | |
|---|---|
| DiscoveredSLRelaysInfo-rxy::= | SEQUENCE { |
| slRelayID-rxy-rxy | RNTI-Value OPTIONAL |
| slCarrierFreq-rxy | ARFCN-ValueNR OPTIONAL |
| slConnection-rxy | ENUMERATED{true} |
| sltimeSpent-rxy | INTEGER (0..4095), |
| slTimeSpentConnected-rxy | INTEGER (0..4095) |
| concurrentCoverageSLRelays | SEQUENCE (SIZE (1..maxSLRelayHistory- |

rxy)) OF INTEGER (0.. maxSLRelayHistory-rxy-1)
...
}
-- TAG-VISITEDCELLINFOLIST-STOP
-- ASN1STOP

VisitedCellInfoList field descriptions

timeSpent
This field indicates the duration of stay in the cell or in any cell selection state and/or camped on any cell state
in NR or E-UTRA approximated to the closest second. If included in VisitedPSCellInfo, it indicates the duration
of stay in the PSCell or without any PSCell. If the duration of stay exceeds 4095 s, the UE shall set it to 4095 s.
visitedCellId
This field indicates the visited cell id including NR and E-UTRA cells.
slRelayID
The ID of the discovered sidelink relay.
slCarrierFreq
The carrier frequency in which the discovered sidelink relay is operating.
slConnection
This field indicates whether the UE has established an sidelink RRC connection with the discovered sidelink
relay UE.
sltimeSpent
This field indicates the duration of stay under the coverage of the sidelink relay UE, or the duration of stay
without any sidelink relay coverage
slTimeSpentConnected
This field indicates the duration of stay connected with the sidelink relay UE
concurrentCoverageSLRelays
This field indicates which of the previous entries of the DiscoveredSLRelaysInfoList are associated to sidelink
relay UEs that were in coverage of the UE when the sidelink relay UE associated to the latest entry of
DiscoveredSLRelaysInfoList was discovered.

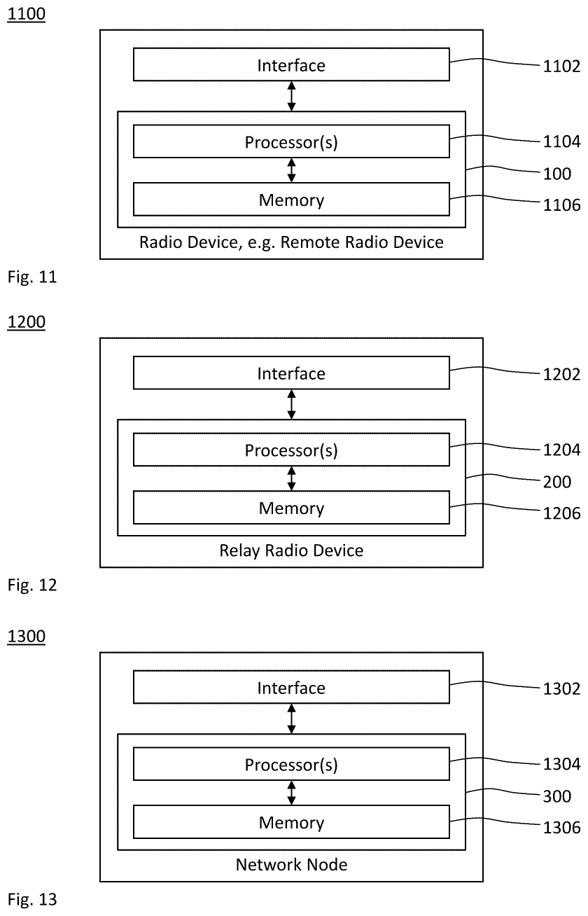

FIG. 11 shows a schematic block diagram for an embodiment of the device 100. The device 100 comprises processing circuitry, e.g., one or more processors 1104 for performing the method 400 and memory 1106 coupled to the processors 1104. For example, the memory 1106 may be encoded with instructions that implement at least one of the modules 102, 104 and 106.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1106, (e.g., remote) radio device functionality. For example, the one or more processors 1104 may execute instructions stored in the memory 1106. Such functionality may include providing various features and steps discussed herein, including any of the benefits disclosed herein. The expression “the device being operative to perform an action” may denote the device 100 being configured to perform the action.

As schematically illustrated in FIG. 11, the device 100 may be embodied by a radio device 1100, e.g., functioning as a UE. The radio device 1100 comprises a radio interface 1102 coupled to the device 100 for radio communication with one or more network node and/or relay radio device.

FIG. 12 shows a schematic block diagram for an embodiment of the device 200. The device 200 comprises processing circuitry, e.g., one or more processors 1204 for performing the method 500 and memory 1206 coupled to the processors 1204. For example, the memory 1206 may be encoded with instructions that implement at least one of the modules 202, 204 and 206.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1206, relay radio device functionality. For example, the one or more processors 1204 may execute instructions stored in the memory 1206. Such functionality may include providing various features and steps discussed herein, including any of the benefits disclosed herein. The expression “the device being operative to perform an action” may denote the device 200 being configured to perform the action.

As schematically illustrated in FIG. 12, the device 200 may be embodied by a relay radio device 1200, e.g., functioning as a relay UE. The relay radio device 1200 comprises a radio interface 1202 coupled to the device 200 for radio communication with one or more radio devices and/or network nodes.

FIG. 13 shows a schematic block diagram for an embodiment of the device 300. The device 300 comprises processing circuitry, e.g., one or more processors 1304 for performing the method 600 and memory 1306 coupled to the processors 1304. For example, the memory 1306 may be encoded with instructions that implement at least one of the modules 302, 304 and 306.

The one or more processors 1304 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 1306, network node and/or RAN functionality. For example, the one or more processors 1304 may execute instructions stored in the memory 1306. Such functionality may include providing various features and steps discussed herein, including any of the benefits disclosed herein. The expression “the device being operative to perform an action” may denote the device 300 being configured to perform the action.

As schematically illustrated in FIG. 13, the device 300 may be embodied by a network node 1300, e.g., functioning as the first network node. The network node 1300 comprises a radio interface 1302 coupled to the device 300 for radio communication with one or more relay radio device and/or (directly with) the radio device, e.g., functioning as a UE.

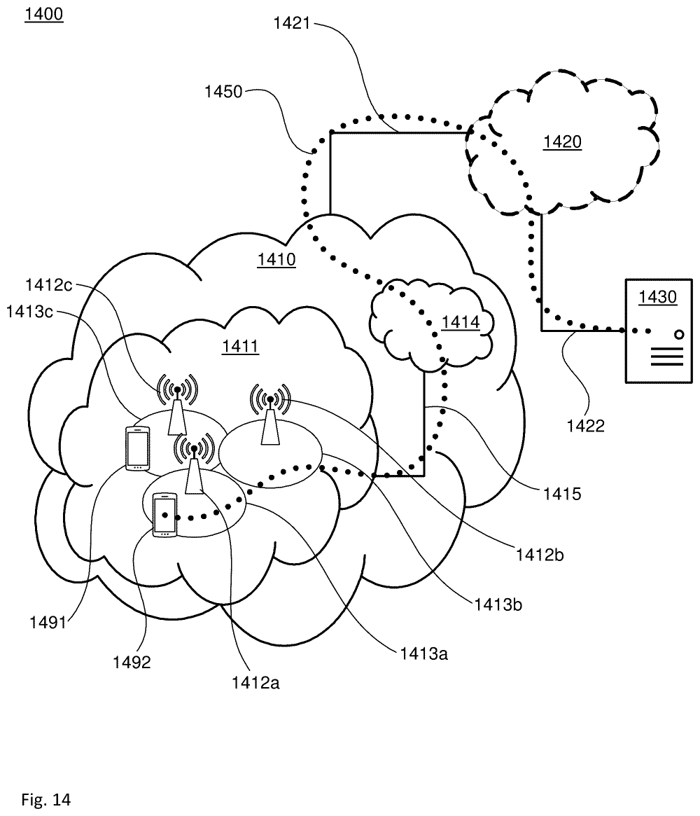

With reference to FIG. 14, in accordance with an embodiment, a communication system 1400 includes a telecommunication network 1410, such as a 3GPP-type cellular network, which comprises an access network 1411, such as a radio access network, and a core network 1414. The access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to the core network 1414 over a wired or wireless connection 1415. A first user equipment (UE) 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Any of the base stations 1412 may embody the device 300, and any one of the UEs 1491, 1492 may embody at least one of the devices 100 and 200.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. The connections 1421, 1422 between the telecommunication network 1410 and the host computer 1430 may extend directly from the core network 1414 to the host computer 1430 or may go via an optional intermediate network 1420. The intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system 1400 of FIG. 14 as a whole enables connectivity between one of the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, the core network 1414, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, a base station 1412 need not be informed about the past routing of an incoming downlink communication with data originating from a host computer 1430 to be forwarded (e.g., handed over) to a connected UE 1491. Similarly, the base station 1412 need not be aware of the future routing of an outgoing uplink communication originating from the UE 1491 towards the host computer 1430.

By virtue of the method 400 and/or 500 being performed by any one of the UEs 1491 or 1492 and/or any one of the base stations 1412 performing the method 600, the performance or range of the OTT connection 1450 can be improved, e.g., in terms of increased throughput and/or reduced latency and/or improved reliability. More specifically, the host computer 1430 may indicate to the first network node 300 or the relay radio device 200 or the (e.g., remote) radio device 100 (e.g., on an application layer) the QoS of the traffic, which may trigger performing at least one of the methods 400, 500, and 600.

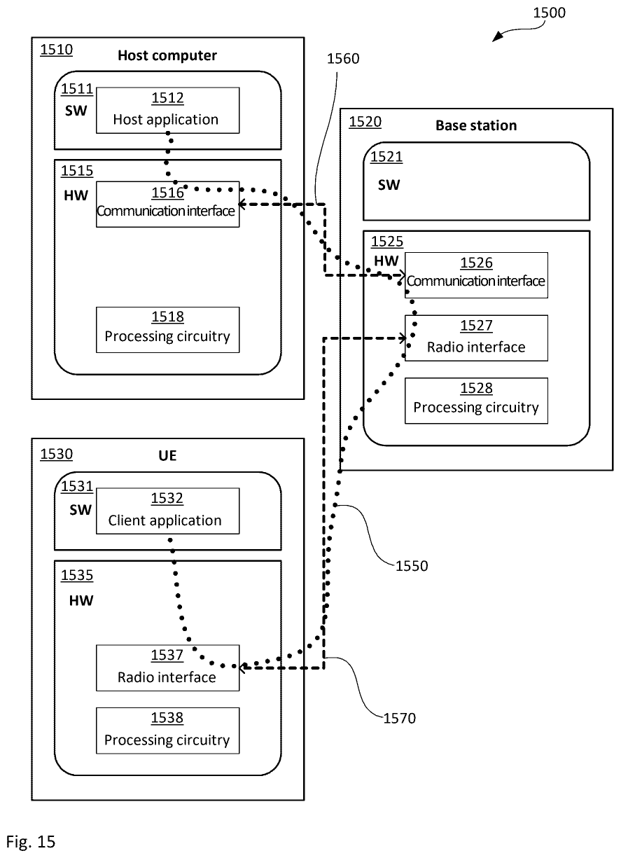

Example implementations, in accordance with an embodiment of the UE, base station and host computer discussed in the preceding paragraphs, will now be described with reference to FIG. 15. In a communication system 1500, a host computer 1510 comprises hardware 1515 including a communication interface 1516 configured to set up and maintain a wired or wireless connection with an interface of a different communication device of the communication system 1500. The host computer 1510 further comprises processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 1511, which is stored in or accessible by the host computer 1510 and executable by the processing circuitry 1518. The software 1511 includes a host application 1512. The host application 1512 may be operable to provide a service to a remote user, such as a UE 1530 connecting via an OTT connection 1550 terminating at the UE 1530 and the host computer 1510. In providing the service to the remote user, the host application 1512 may provide user data, which is transmitted using the OTT connection 1550. The user data may depend on the location of the UE 1530. The user data may comprise auxiliary information or precision advertisements (also: ads) delivered to the UE 1530. The location may be reported by the UE 1530 to the host computer, e.g., using the OTT connection 1550, and/or by the base station 1520, e.g., using a connection 1560.

The communication system 1500 further includes a base station 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with a UE 1530 located in a coverage area (not shown in FIG. 15) served by the base station 1520. The communication interface 1526 may be configured to facilitate a connection 1560 to the host computer 1510. The connection 1560 may be direct, or it may pass through a core network (not shown in FIG. 15) of the telecommunication system and/or through one or more intermediate networks outside the telecommunication system. In the embodiment shown, the hardware 1525 of the base station 1520 further includes processing circuitry 1528, which may comprise one or more programmable processors, application-specific integrated circuits, field programmable gate arrays or combinations of these (not shown) adapted to execute instructions. The base station 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a base station serving a coverage area in which the UE 1530 is currently located. The hardware 1535 of the UE 1530 further includes processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, base station 1520 and UE 1530 illustrated in FIG. 15 may be identical to the host computer 1430, one of the base stations 1412a, 1412b, 1412c and one of the UEs 1491, 1492 of FIG. 14, respectively. This is to say, the inner workings of these entities may be as shown in FIG. 15, and, independently, the surrounding network topology may be that of FIG. 14.

In FIG. 15, the OTT connection 1550 has been drawn abstractly to illustrate the communication between the host computer 1510 and the UE 1530 via the base station 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

The wireless connection 1570 between the UE 1530 and the base station 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1550 between the host computer 1510 and UE 1530, in response to variations in the measurement results. The measurement procedure and/or the network functionality for reconfiguring the OTT connection 1550 may be implemented in the software 1511 of the host computer 1510 or in the software 1531 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of the OTT connection 1550 may include message format, retransmission settings, preferred routing etc.; the reconfiguring need not affect the base station 1520, and it may be unknown or imperceptible to the base station 1520. Such procedures and functionalities may be known and practiced in the art. In certain embodiments, measurements may involve proprietary UE signaling facilitating the host computer's 1510 measurements of throughput, propagation times, latency and the like. The measurements may be implemented in that the software 1511, 1531 causes messages to be transmitted, in particular empty or “dummy” messages, using the OTT connection 1550 while it monitors propagation times, errors etc.

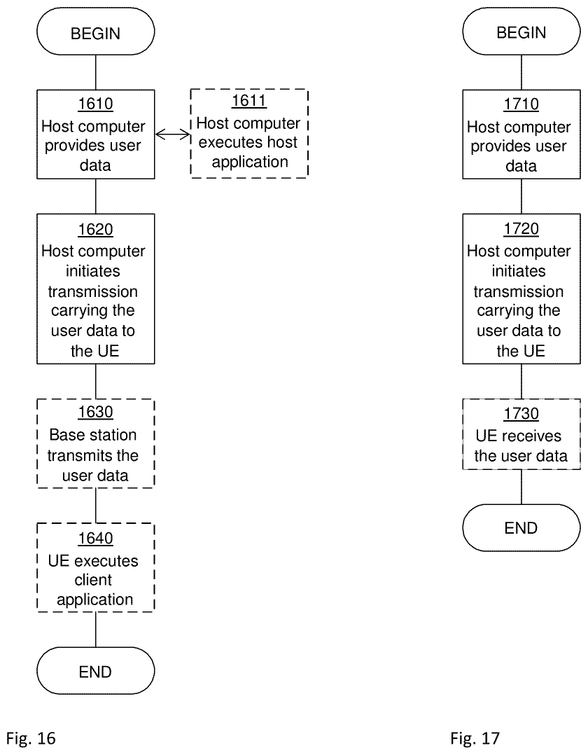

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this paragraph. In a first step 1610 of the method, the host computer provides user data. In an optional substep 1611 of the first step 1610, the host computer provides the user data by executing a host application. In a second step 1620, the host computer initiates a transmission carrying the user data to the UE. In an optional third step 1630, the base station transmits to the UE the user data which was carried in the transmission that the host computer initiated, in accordance with the teachings of the embodiments described throughout this disclosure. In an optional fourth step 1640, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this paragraph. In a first step 1710 of the method, the host computer provides user data. In an optional substep (not shown) the host computer provides the user data by executing a host application. In a second step 1720, the host computer initiates a transmission carrying the user data to the UE. The transmission may pass via the base station, in accordance with the teachings of the embodiments described throughout this disclosure. In an optional third step 1730, the UE receives the user data carried in the transmission.

As has become apparent from above description, at least some embodiments of the technique enable a radio device (e.g., a UE) to report to the network (e.g., the RAN, particularly the first network node) times when the radio device is (e.g., including when the radio device was) in and/or out of coverage considering both direct coverage by the network (e.g., Uu connectivity) and indirect coverage (e.g., sidelink connectivity). Same or further embodiments enable a radio device (e.g., a UE) to report times when the UE has (e.g., including when the radio device had) no connectivity at all and/or when the radio device only has (e.g., including when the radio device had) connectivity via a (e.g., sidelink) relay, etc.

Any one of the embodiments may assist an operator of the network (e.g., the RAN) and/or may control the network (e.g., the RAN) based on a coverage area associated with the network, wherein the coverage area is indicative of where (i.e., where in the network) the radio devices (e.g., the UEs) are experiencing outage completely and/or where the radio devices are experiencing outage on a Uu link, but not on a sidelink, etc. This allows the network or the network operator to get a better picture of the coverage situation in the network and hence can make more educated adjustments to the network, for example address problems where there is no coverage at all.

Furthermore, any one of the embodiments of the radio device (or UE), the relay radio device (or relay UE), and the first network node (or gNB) may be implemented according to, or by enhancing, the 3GPP document TR 23.752, version 17.0.0 and/or the 3GPP document TS 38.836, version 17.0.0 and/or the 3GPP document TS 38.331, version 17.1.0.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method performed by a radio device, the method comprising or initiating:
transmitting a report message to a first network node of a radio access network, RAN, associated with a coverage area, the report message being indicative of a coverage status of the radio device relative to the RAN, wherein the report message is indicative of an indirect coverage of the RAN through one or more relay radio devices.

2. The method of claim 1, wherein the indirect coverage is provided through at least one of the relay radio devices by the first network node, optionally by at least one cell or at least one beam of the first network node, and/or wherein the RAN further comprises at least one second network node and the indirect coverage is provided through at least one of the relay radio devices by the at least one second network node, optionally by at least one cell or at least one beam of the at least one second network node.

3. The method of claim 1, wherein the report message is further indicative of a direct coverage of the RAN.

4. The method of claim 3, wherein the direct coverage is provided by the first network node, optionally by at least one cell or at least one beam of the first network node, and/or
wherein the RAN further comprises at least one second network node and the direct coverage is provided by the at least one second network node, optionally by at least one cell or at least one beam of the at least one second network node.

5. The method of claim 3, wherein the report message differentiates between the direct coverage and the indirect coverage.

6. The method of claim 3, wherein the report message is indicative of the direct coverage and the indirect coverage indistinguishably from each other within the report.

7. The method claim 1, wherein the report message is further indicative of lacking coverage of the radio device relative to the RAN.

8. The method of claim 7, wherein the lacking coverage comprises the absence of both direct coverage of the RAN and indirect coverage of the RAN.

9. The method claim 1, wherein the report message is further indicative of at least one of:
an identity and/or a number and/or a signal metric of at least one of the respective network node, the cell, and the beam providing the indirect coverage;
an identity and/or a number and/or a signal metric of the respective relay radio device through which the indirect coverage is provided;
an identity and/or a number and/or a signal metric of at least one of the respective network node, the cell, and the beam providing the direct coverage; and
an identity and/or a number and/or a signal metric of at least one of the respective network node, the cell, and the beam causing the lacking coverage.

10. The method claim 1, wherein the report message is indicative of a sequence and/or a map of the coverage status of the radio device, optionally comprising at least one of:
a sequence and/or a map of the indirect coverage;
a sequence and/or a map of the direct coverage; and
a sequence and/or a map of the lacking coverage.

11. The method claim 1, wherein the coverage status of the radio device comprises a multi-connectivity, MC, of the radio device concurrently using multiple independent radio paths to the RAN, and wherein at least one or each of the multiple radio paths uses the indirect coverage of the RAN through at least one of the one or more relay radio devices.

12. The method claim 1, wherein the coverage status of the radio device comprises a handover, HO, of the radio device from a source radio path between the radio device and the RAN to a target radio path between the radio device and the RAN, and wherein at least one or each of the source radio path and the target radio path uses the indirect coverage of the RAN through at least one of the one or more relay radio devices.

13. The method claim 3, wherein the coverage status of the radio device comprises the direct coverage of the RAN while the radio device discovers at least one of the one or more relay radio devices through which the indirect coverage of the RAN is provided,
optionally wherein the radio device uses concurrently the direct coverage and the indirect coverage for a or the MC of the radio device, or wherein the radio device is handed over from the direct coverage to the indirect coverage.

14. The claim 1, wherein the coverage status of the radio device comprises the indirect coverage of the RAN through a first relay radio device of the relay radio devices while the radio device discovers a second relay radio device of the relay radio devices through which the indirect coverage of the RAN is provided,
optionally wherein the radio device uses concurrently the indirect coverage through the first relay radio device and the indirect coverage through the second relay radio device for a or the MC of the radio device, or wherein the radio device is handed over from the indirect coverage through the first relay radio device to the indirect coverage through the second relay radio device.

15. The method claim 1, wherein storing of information at the radio device as to the coverage status and/or the transmitting of the report message is triggered by at least one of:
receiving a configuration message or a request message from the RAN;
determining the lacking coverage of the RAN;
establishing a connection with, or camping on, the first network node using the direct coverage or using the indirect coverage;
establishing a connection with, or camping on, the at least one second network node using the direct coverage or using the indirect coverage;
discovering, by the radio device, the one or more relay radio devices or at least one of the one or more relay radio devices for the indirect coverage;
discovering, by the radio device, the first network node or the at least one second network node of the RAN;
establishing a sidelink to at least one of the one or more relay radio devices;
a change in the coverage status of the radio device relative to the RAN; and
an expiry of a predefined period of time.

16. The method claim 1, further comprising or initiating:
transmitting a status message to the RAN, optionally to the first network node or the at least one second network node.

17. The method claim 1, wherein at least one of the status message and the report message is indicative of at least one of:
an availability of information at the radio device as to the coverage status of the radio device relative to the RAN, optionally wherein the status message is indicative of different time spans and/or different locations for which the information at the radio device as to the coverage status of the radio device relative to the RAN is available;
an availability of information at the radio device as to the indirect coverage of the RAN through one or more relay radio devices, optionally wherein the status message is indicative of different time spans and/or different locations for which the information at the radio device as to the indirect coverage of the RAN is available;
an availability of information at the radio device as to the direct coverage of the RAN, optionally wherein the status message is indicative of different time spans and/or different locations for which the information at the radio device as to the direct coverage of the RAN is available;
an availability of information at the radio device as to the lacking coverage of the RAN, optionally wherein the status message is indicative of different time spans and/or different locations for which the information at the radio device as to the lacking coverage of the RAN is available;
a time span of the radio device being in indirect coverage of the RAN, optionally per network node or per cell or per beam or per relay radio device;
a capability of the radio device to be in or use the indirect coverage of a RAN, optionally per radio access technology, RAT, of the RAN or per RAT of a sidelink between the radio device and the at least one relay radio device;
a time span of the radio device being in direct coverage of the RAN, optionally per network node or per cell or per beam;
a time span of the radio device being out of coverage of the RAN;
a number and/or a list of identities of the one or more relay radio devices through which the radio device is or has been in indirect coverage of the RAN, optionally per network node or per cell or per beam;
a frequency on which the indirect coverage is provided through the at least one relay radio device, optionally per network node or per cell or per beam or per relay radio device;
a signal metric of the RAN measured at the relay radio device through which the indirect coverage is provided, optionally per network node or per cell or per beam or per relay radio device;
a signal metric of the relay radio device measured at the radio device for the indirect coverage, optionally per network node or per cell or per beam or per relay radio device; and
a radio access technology and/or a type and/or a mode of a sidelink between the radio device and the relay radio device.

18. The method claim 1, further comprising or initiating:
receiving a or the request message from the RAN, optionally from the first network node or the at least one second network node, or from the one or more relay radio devices.

19-22. (canceled)

23. A method performed by a relay radio device, the method comprising or initiating:
receiving a report message from a radio device that is out of direct coverage of a radio access network, RAN, the report message being indicative of a coverage status of the radio device relative to the RAN, wherein the report message is indicative of an indirect coverage of the RAN through one or more relay radio devices; and
transmitting the report message to a first network node of the RAN.

24-25. (canceled)

26. A method performed by a first network node of a radio access network, RAN, associated with a coverage area, the method comprising or initiating:
receiving a report message from a radio device, the report message being indicative of a coverage status of the radio device relative to the RAN, wherein the report message is indicative of an indirect coverage of the RAN through one or more relay radio devices.

27-48. (canceled)
